(19) United States
(12) Patent Application Publication
(10) Pub. No.: US 2025/0310740 A1
(43) Pub. Date: Oct. 2, 2025

(54) FEDERATED EAS DISCOVERY

(71) Applicant: Telefonaktiebolaget LM Ericsson (publ), Stockholm (SE)

(72) Inventor: Wenliang XU, Shanghai (CN)

(21) Appl. No.: 18/864,332

(22) PCT Filed: May 8, 2023
(86) PCT No.: PCT/CN2023/092702

§ 371 Date: Nov. 8, 2024

(30) Foreign Application Priority Data
May 10, 2022 (WO) PCT/CN2022/092005
Aug. 15, 2022 (WO) PCT/CN2022/112475

(51) Int. Cl. H04W 4/50; H04L 41/5003

(52) U.S. Cl. CPC H04W 4/50; H04L 41/5003

(57) ABSTRACT

A method performed by a functional component implementing an enabler function in a User Equipment (UE). In an embodiment, the method may include transmitting, to a first network function implementing an Edge Configuration Server (ECS), a first request message for service provisioning. Receiving, from the first network function, a first response message. The first response message may include a first parameter indicating information related to a second network function implementing an Edge Enabler Server (EES) managed by the first network function, and a second parameter indicating information related to a third network function implementing an EES managed by a fourth network function implementing an ECS. The embodiments may allow the ECS to discover a target EES having a Service Layer Agreement (SLA) with a source EES based on the federation agreements between Edge Computing Service Providers (ECSPs), before EDGE-9 interaction.

### CROSS REFERENCE TO RELATED APPLICATION

This application claims priorities of PCT Application Serial Number PCT/CN2022/092005 filed on May 10, 2022 with title of “FEDERATED EAS DISCOVERY” and PCT Application Serial Number PCT/CN2022/112475 filed on Aug. 15, 2022 with title of “FEDERATED EAS DISCOVERY”, the entire contents of which are incorporated herein by reference.

### TECHNICAL FIELD

The embodiments herein relate generally to the field of edge computing, and more particularly, the embodiments herein relate to federated Edge Application Server (EAS) discovery.

### BACKGROUND

The third Generation Partnership Project (3GPP) Technical Specification (TS) 23.558 Release 17 (v17.3.0) specifies the application layer architecture, procedures and information flows necessary for enabling edge applications over 3GPP networks. It includes architectural requirements for enabling edge applications, application layer architecture fulfilling the architecture requirements and procedures to enable the deployment of edge applications.

FIG. 1 is a schematic block diagram showing example architecture of a wireless communication system 100 for enabling edge applications. The Edge Data Network (EDN) 102 is a local data network. The EASs 122 and the Edge Enabler Server (EES) 121 are contained within the EDN 102. The Edge Configuration Server (ECS) 103 provides configurations related to the EES 121, including details of the EDN 102 hosting the EES 121. The User Equipment (UE) 101 contains Application Client(s) (AC) 112 and the Edge Enabler Client (EEC) 111. The EAS(s) 122, the EES(s) 121 and the ECS 103 may interact with the 3GPP Core Network 104.

There are several unsolved key issues when discussing the next release, for example Release 18.

### SUMMARY

The embodiments herein propose methods, UEs, network functions, computer readable medium and computer program product for federated EAS discovery.

In some embodiments, there proposes a method performed by a functional component implementing an enabler function in a UE. In an embodiment, the method may comprise the step of transmitting, to a first network function implementing an ECS, a first request message for service provisioning. The method may further comprise the step of receiving, from the first network function, a first response message. The first response message may include a first parameter indicating information related to a second network function implementing an EES managed by the first network function, and a second parameter indicating information related to a third network function implementing an EES managed by a fourth network function implementing an ECS.

In an embodiment, the first network function may have an edge service federation with the fourth network function. In an embodiment, the second network function may use the edge service federation for validating the third network function. In an embodiment, the edge service federation may be a Service Layer Agreement (SLA).

In an embodiment, the method may further comprise the step of transmitting, to the second network function, a second request message for EAS discovery; the second request message may include the second parameter. In an embodiment, the method may comprise the step of receiving, from the second network function, a second response message including information related to one or more EASs.

In an embodiment, the first request message may be a service provisioning request message over Edge-4 reference point. In an embodiment, the first response message may be a service provisioning response message over Edge-4 reference point. In an embodiment, the second request message may be an EAS discovery request message over Edge-1 reference point. In an embodiment, the second response message may be an EAS discovery response message over Edge-1 reference point.

In an embodiment, the second parameter may be received in a way that is transparent to the functional component and/or UE. In an embodiment, the second parameter may be included in an access token generated by the first network function.

In some embodiments, there proposes a method performed by a first network function implementing an ECS. In an embodiment, the method may comprise the step of receiving, from a functional component implementing an enabler function in a UE, a first request message for service provisioning. The method may further comprise the step of determining a fourth network function implementing an ECS, based on an edge service federation. The method may further comprise the step of receiving, from the fourth network function, a message including a second parameter indicating information related to a third network function implementing an EES managed by the fourth network function. The method may further comprise the step of determining a second network function implementing an EES, which is managed by the first network function based on the edge service federation. In an embodiment, the edge service federation may be a SLA.

In an embodiment, the method may further comprise the step of transmitting, to the functional component in the UE, a first response message. The first response message may include a first parameter indicating information related to the second network function, and the second parameter indicating information related to the third network function.

In an embodiment, the first request message may be a service provisioning request message over Edge-4 reference point. In an embodiment, the first response message may be a service provisioning response message over Edge-4 reference point. In an embodiment, the message including the second parameter may be received over Edge-10 reference point.

In an embodiment, the second parameter may be transmitted in a way that is transparent to the first functional component. In an embodiment, the second parameter may be included in an access token generated by the first network function.

In some embodiments, there proposes a method performed by a first network function implementing an ECS. In an embodiment, the method may comprise the step of receiving a first request message for service provisioning, from a functional component implementing an enabler function in a UE. The method may further comprise the step of determining a second network function implementing an EES, based on the stored information which was received from a fourth network function implementing an ECS. The second network function may be managed by the first network function having an edge service federation with the fourth network function. The method may further comprise the step of transmitting a first response message including a first parameter indicating information related to the determined second network function, to the functional component in the UE. In an embodiment, the edge service federation may be a SLA.

In an embodiment, the first request message may be a service provisioning request message over Edge-4 reference point. In an embodiment, the first response message may be a service provisioning response message over Edge-4 reference point. In an embodiment, the first parameter may indicate the endpoint of the determined second network function.

In some embodiments, there proposes a method performed by a functional component implementing an enabler function in a UE. In an embodiment, the method may comprise the step of transmitting, to a second network function implementing an EES, a second request message for EAS discovery; the second request message may include a second parameter indicating information related to a third network function implementing an EES. In an embodiment, the second network function and the third network function may be managed by different ECSs having an edge service federation. In an embodiment, the method may further comprise the step of receiving, from the second network function, a second response message including information related to one or more EASs. In an embodiment, the edge service federation may be a SLA.

In an embodiment, the second request message may be an EAS discovery request message over Edge-1 reference point. In an embodiment, the second response message may be an EAS discovery response message over Edge-1 reference point.

In an embodiment, the second parameter may be included in an access token.

In some embodiments, there proposes a method performed by a second network function implementing an EES. In an embodiment, the method may comprise the step of receiving, from a functional component implementing an enabler function in a UE, a second request message for EAS discovery; the second request message may include a second parameter indicating information related to a third network function implementing an EES. In an embodiment, the second network function and the third network function may be managed by different ECSs having an edge service federation. In an embodiment, the method may further comprise the step of transmitting, to the functional component, a second response message including information related to one or more EASs. In an embodiment, the edge service federation may be a SLA.

In an embodiment, the method may further comprise the step of validating the third network function based on the edge service federation.

In an embodiment, the method may further comprise the step of transmitting, to the third network function, a third request message for EAS discovery. In an embodiment, the method may further comprise the step of receiving, from the third network function, a third response message including information related to the one or more EASs.

In an embodiment, the second request message may be an EAS discovery request message over Edge-1 reference point. In an embodiment, the second response message may be an EAS discovery response message over Edge-1 reference point. In an embodiment, the third request message may be an EAS discovery request message over Edge-9 reference point. In an embodiment, the third response message may be an EAS discovery response message over Edge-9 reference point.

In an embodiment, the second parameter may be included in an access token. In an embodiment, the method may further comprise the step of decoding the encrypted access token to obtain the second parameter.

In some embodiments, there proposes a method performed by a second network function implementing an EES. In an embodiment, the method may comprise the step of receiving, from a functional component implementing an enabler function in a UE, a second request message for EAS discovery. The method may further comprise the step of determining a third network function implementing an EES, based on an edge service federation. The method may further comprise the step of transmitting, to the determined third network function, a third request message for EAS discovery. The method may further comprise the step of receiving a third response message including information related to one or more EASs from the third network function. The method may further comprise the step of transmitting a second response message including information related to the one or more EASs to the functional component.

In an embodiment, determining the third network function may further comprise the step of transmitting a fourth request message for retrieving a network function, to a first network function implementing an ECS. Determining the third network function may further comprise the step of receiving a fourth response message including information related to the third network function, from the first network function. In an embodiment, the fourth request message may further include an indicator indicating that edge node sharing (ENS) is requested.

In an embodiment, the second network function and the third network function may be managed by different ECSs having an edge service federation. In an embodiment, the edge service federation may be a SLA.

In an embodiment, the second request message may be an EAS discovery request message over Edge-1 reference point. In an embodiment, the second response message may be an EAS discovery response message over Edge-1 reference point. In an embodiment, the third request message may be an EAS discovery request message over Edge-9 reference point. In an embodiment, the third response message may be an EAS discovery response message over Edge-9 reference point. In an embodiment, the fourth request message may be a retrieve EES request message over Edge-6 reference point. In an embodiment, the fourth response message may be a retrieve EES response message over Edge-6 reference point.

In some embodiments, there proposes a method performed by a first network function implementing an ECS. In an embodiment, the method may comprise the step of receiving a fourth request message for retrieving a network function, from a second network function implementing an EES. The method may further comprise the step of determining a third network function implementing an EES, based on an edge service federation. The method may further comprise the step of transmitting a fourth response message including information related to the third network function, to the second network function.

In an embodiment, the fourth request message may further include an indicator indicating that an edge node sharing is requested. In an embodiment, determining the third network function may be based on the stored information which was received from a fourth network function implementing an ECS.

In an embodiment, the first network function may have an edge service federation with the fourth network function. In an embodiment, the edge service federation may be a SLA.

In an embodiment, the fourth request message may be a retrieve EES request message over Edge-6 reference point. In an embodiment, the fourth response message may be a retrieve EES response message over Edge-6 reference point.

In some embodiments, there proposes a method performed by a third network function implementing an EES. In an embodiment, the method may comprise the step of receiving, from a second network function implementing an EES, a third request message for EAS discovery. In an embodiment, the second network function and the third network function may be managed by different ECSs having edge service federation. In an embodiment, the method may further comprise the step of validating the second network function based on the edge service federation. In an embodiment, the method may further comprise the step of transmitting, to the second network function, a third response message including information related to one or more EASs. In an embodiment, the edge service federation is a SLA.

In an embodiment, the third request message may be an EAS discovery request message over Edge-9 reference point. In an embodiment, the third response message may be an EAS discovery response message over Edge-9 reference point.

In some embodiments, there proposes a method performed by a first network function implementing an ECS. In an embodiment, the method may comprise the step of receiving a fifth message related to information publish, from a fourth network function implementing an ECS. The method may further comprise the step of changing previously stored information according to the fifth message. In an embodiment, the method may further comprise the step of transmitting, to the fourth network function, a sixth message. In an embodiment, the first network function may have an edge service federation with the fourth network function.

In an embodiment, the fifth message related to information publish may be an application information publish request message over Edge-10 reference point. In an embodiment, the sixth message may be an application information publish response message over Edge-10 reference point. In an embodiment, the fifth message may include a list of EAS Ids or includes a list of EAS Ids and information related to an EES. In an embodiment, changing the previously stored information may further comprise the step of storing the information included in the fifth message.

In an embodiment, the fifth message related to information publish may be an application information publish update request message over Edge-10 reference point. In an embodiment, the sixth message may be an application information publish update response message over Edge-10 reference point. In an embodiment, the fifth message may include at least one of a list of EAS Ids and information related to an EES. In an embodiment, changing the previously stored information may further comprise the step of updating the previously stored information by using the information included in the fifth message.

In an embodiment, the fifth message related to information publish may be an application information unpublish request message over Edge-10 reference point. In an embodiment, the sixth message may be an application information unpublish response message over Edge-10 reference point. In an embodiment, changing the stored information may further comprise the step ofremoving the previously stored information.

In an embodiment, the fifth message related to information publish may be a fetch application information response message over Edge-10 reference point. In an embodiment, the sixth message may be a fetch application information request message over Edge-10 reference point. In an embodiment, the fifth message may include at least one of a list of EAS Ids and information related to an EES. In an embodiment, changing the previously stored information may further comprise the step of updating the previously stored information by using the information included in the fifth message.

In some embodiments, there proposes a method performed by a fourth network function implementing an ECS. In an embodiment, the method may comprise the step of transmitting a fifth message related to information publish, to a first network function implementing an ECS. The method may further comprise the step of receiving a sixth message from the first network function. In an embodiment, the method may further comprise the step of receiving a seventh request message related to EES registration, from a third network function implementing an EES. In an embodiment, the first network function may have an edge service federation with the fourth network function.

In an embodiment, the seventh request message related to EES registration may be an EES registration message. In an embodiment, the fifth message related to information publish may be an application information publish request message over Edge-10 reference point. In an embodiment, the sixth message may be an application information publish response message over Edge-10 reference point. In an embodiment, the fifth message may include a list of EAS Ids or include a list of EAS Ids and information related to the third network function.

In an embodiment, the seventh request message related to EES registration may be an EES registration update message. In an embodiment, the fifth message related to information publish may be an application information publish update request message over Edge-10 reference point. In an embodiment, the sixth message may be an application information publish update response message over Edge-10 reference point. In an embodiment, the fifth message may include at least one of a list of EAS Ids and information related to the third network function.

In an embodiment, the seventh request message related to EES registration may be an EES de-registration message. In an embodiment, the fifth message related to information publish may be an application information unpublish request message over Edge-10 reference point. In an embodiment, the sixth message may be an application information unpublish response message over Edge-10 reference point.

In an embodiment, the fifth message related to information publish may be a fetch application information response message over Edge-10 reference point. In an embodiment, the sixth message may be a fetch application information request message over Edge-10 reference point. In an embodiment, the fifth message may include at least one of a list of EAS Ids and information related to an EES.

In some embodiments, there proposes a UE, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above UE. In an embodiment, the UE may be configured as the above UE.

In some embodiments, there proposes a network function, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above network functions. In an embodiment, the network function may be configured as any of the above first network function, second network function, third network function, or fourth network function.

In some embodiments, there proposes a computer readable medium stores computer readable code, which when run on an apparatus, causes the apparatus to perform any of the above methods.

In some embodiments, there proposes a computer program product stores computer readable code, which when run on an apparatus, causes the apparatus to perform any of the above methods.

The embodiments may solve several unsolved key issues. The embodiments may allow the ECS to discover a target EES having SLA with a source EES based on the federation agreements between Edge Computing Service Providers (ECSPs), before EDGE-9 interaction. The embodiments may allow the EAS discovery in edge node sharing case.

In some embodiments, the UE may contact with its home operator platform without directly contacting with the partner operator platform, and thus the complexity of the UE may be reduced.

In some embodiments, the EEC in the UE may be unaware of the federated EAS discovery, i.e., the EEC in the UE may do the same actions as the conventional EAS discovery, and thus the impact to the UE may be reduced.

In some embodiments, only the metadata of the EAS(s) of the partner operator platform are published, and thus may reduce the data amount to be transferred on the Edge-10 reference point and to be stored on the ECS.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture of a wireless communication system for enabling Edge applications;

FIG. 2 is a schematic block diagram showing example architecture of another wireless communication system for enabling Edge applications;

FIG. 3 is a schematic block diagram showing relationship between the edge computing architecture and Global System for Mobile Communications Association (GSMA) Operator Platform Group (OPG) reference architecture;

FIG. 4 is a schematic signaling chart showing the messages in an edge discovery procedure in an edge-sharing partner network;

FIG. 5 is a schematic block diagram showing an edge node sharing scenario;

FIG. 6 is a schematic block diagram showing example architecture of a wireless communication system, in which the embodiments may be implemented;

FIG. 7 is a schematic signaling chart showing the messages in an application information publish procedure, according to the embodiments herein;

FIG. 8 is a schematic signaling chart showing the messages in an application information fetch procedure, according to the embodiments herein;

FIG. 9 is a schematic signaling chart showing the messages in a federated EAS discovery procedure, according to the embodiments herein;

FIG. 10 is a schematic signaling chart showing the messages in another federated EAS discovery procedure, according to the embodiments herein;

FIG. 11 is a schematic flow chart showing an example method in the UE,according to the embodiments herein;

FIG. 12 is a schematic flow chart showing an example method in the first network function, according to the embodiments herein;

FIG. 13 is a schematic flow chart showing another example method in the first network function, according to the embodiments herein;

FIG. 14 is a schematic flow chart showing another example method in the UE, according to the embodiments herein;

FIG. 15 is a schematic flow chart showing an example method in the second network function, according to the embodiments herein;

FIG. 16 is a schematic flow chart showing another example method in the second network function, according to the embodiments herein;

FIG. 17 is a schematic flow chart showing yet another example method in the first network function, according to the embodiments herein;

FIG. 18 is a schematic flow chart showing an example method in the third network function, according to the embodiments herein;

FIG. 19 is a schematic flow chart showing still yet another example method in the first network function, according to the embodiments herein;

FIG. 20 is a schematic flow chart showing an example method in the fourth network function, according to the embodiments herein;

FIG. 21 is a schematic block diagram showing an example UE, according to the embodiments herein;

FIG. 22 is a schematic block diagram showing an example network function, according to the embodiments herein;

FIG. 23 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

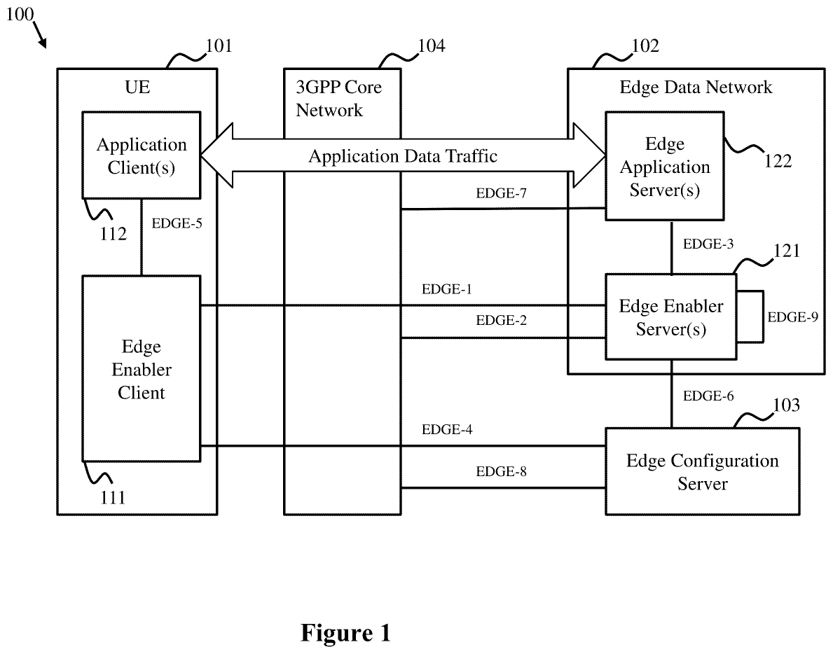

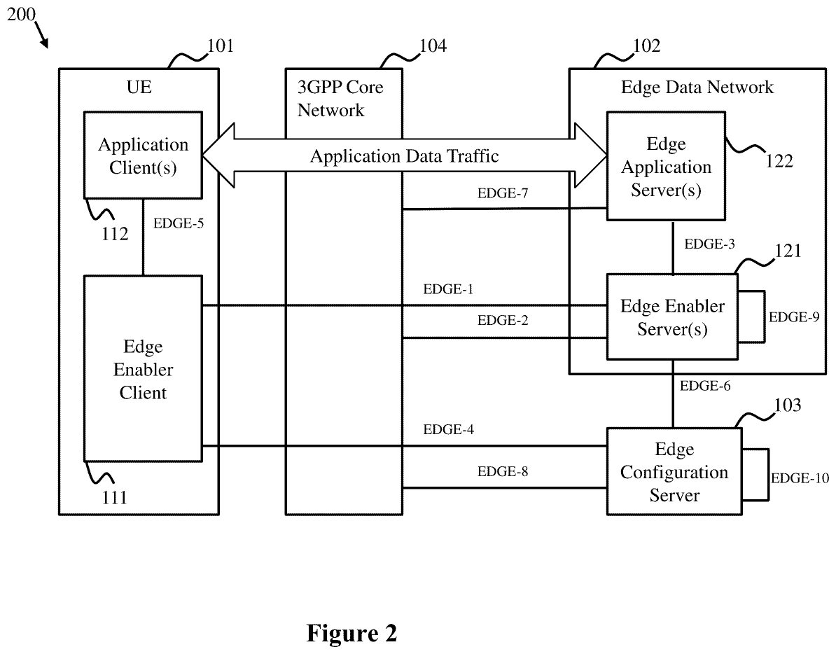

FIG. 2 is a schematic block diagram showing example architecture of another wireless communication system 200 for enabling Edge applications. Compared with architecture of FIG. 1, the architecture of the wireless communication system 200 is enhanced by a new reference point EDGE-10, which is defined between the ECSs. Note that, the ECSs communicating via EDGE-10 may be provided by different Edge Computing Service Providers (ECSPs).

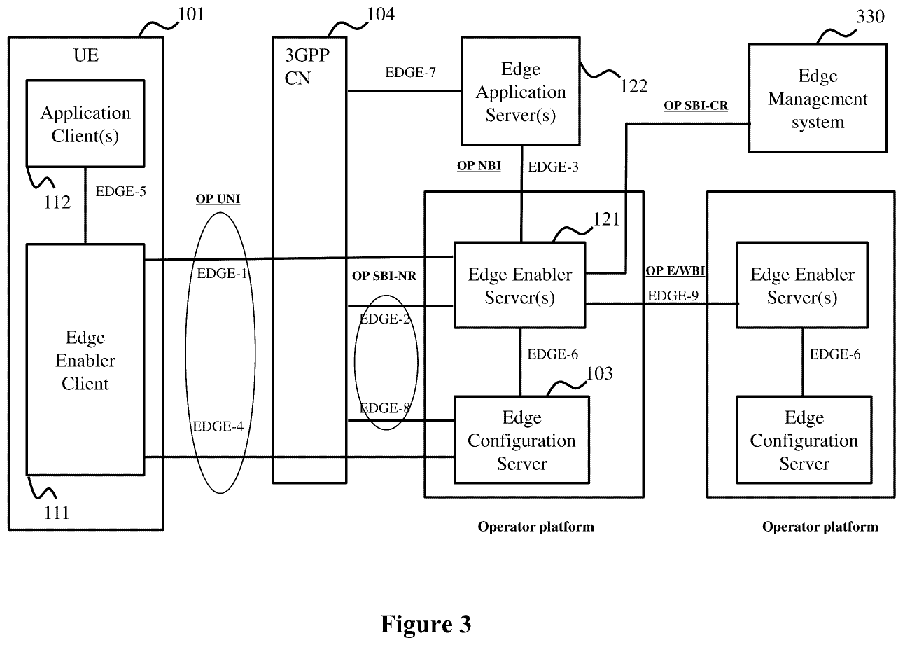

FIG. 3 is a schematic block diagram showing relationship between the edge computing architecture (EDGE APP architecture) and GSMA OPG reference architecture.

As shown in FIG. 3, EDGE-1 and EDGE-4 reference points can support similar function(s) as Operator Platform (OP)'s User-Network interface (UNI), providing the EEC 111 (corresponding to Edge/User Client in the OP) with the information required to access the edge services. EDGE-1/EDGE-4 neither impact nor overlap with other existing 3GPP interfaces between the UE 101 and the network, catering to the OP's requirements on UNI.

EDGE-2 and EDGE-8 reference points can support similar function(s) as OP's Southbound interface (SBI), through which the edge enabler layer (corresponding to the operator platform) may access the 3GPP network capabilities and services. Specifically, EDGE-2 and EDGE-8 cater to the requirements of the SBI-NetworkResource interface. The Edge management system 330 as specified in 3GPP TS 28.538 caters to the requirements of OP's SBI-CloudResource interface.

EDGE-3 reference point can support similar function(s) as OP's Northbound interface (NBI), exposing the capabilities of the EES 121 to the EASs 122 hosted on the edge. OP's NBI also expands capabilities exposure to the Application Service Providers (ASPs), for example to on-board applications to be deployed as EASs 122 based on specific criteria.

EDGE-9 reference point can support similar function(s) as OP's East/Westbound interface (E/WBI), allowing the edge enabler layer to interact within and beyond its domains e.g. between operator platforms. OP's E/WBI focuses on use cases like user and application roaming or resource sharing across domains.

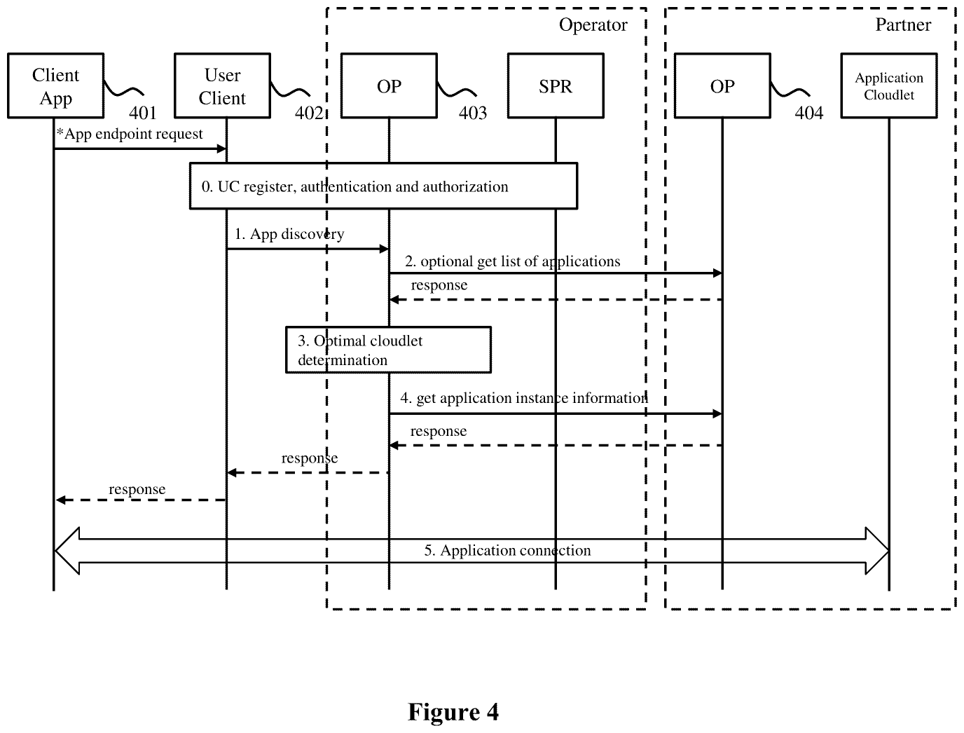

FIG. 4 is a schematic signaling chart showing the messages in an edge discovery procedure in an edge-sharing partner network (refer to Operator Platform Telco Edge Requirements, Version 2.0).

The edge discovery procedure describes the edge discovery when the UE is physically attached to the home operator 403, but the most suitable cloudlet is in an “edge-sharing” partner operator 404.

The edge discovery procedure may include the following messages or steps.

In step 1, a user client 402 on a UE may request a discovery query for a particular application (i.e., the client application 401). The user client 402 may be previously registered with the operator 403 (home operator).

In step 2 (optional), the home operator 403 may trigger a discovery request for the applications available on the partner's resources.

Note that, the partner operator 404 may also publish those available applications independently ofinteractions of the user client 402.

In step 3, the home operator 403 may determine the most optimal application locations, based on local and federated resources from the partner operator 404, and determine that the user is best served by an application instance provided by the partner operator 404.

In step 4, the home operator 403 may request the partner operator 404 for the application instance information to allow the home operator 403 to provide the connection data to the user client 402.

In step 5, the user client 402 may be provided with the connection data of the application instance and connects to it.

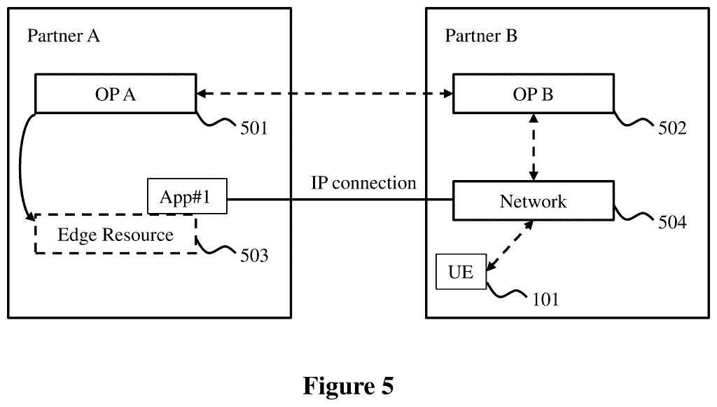

FIG. 5 is a schematic block diagram showing an edge node sharing scenario. As shown in FIG. 5, the UE 101, which is connected to the network 504 of the OP B 502, aims to use the edge resource 503 owned by the OP A 501. However, there are several Key Issues (KIs) unsolved, as described by edge computing study TR 23.700-98 v0.6.0.

KI #6 (Edge services support across ECSPs) says:
“How the ECS can discover a target EES (T-EES) having SLA with a source EES (S-EES) based on the federation agreements between ECSPs before EDGE-9 interaction?”

KI #22 (EAS discovery in Edge Node sharing scenario) says:
“How can EES discover and determine an EAS which allows (subscribers of OP B) to avail its services?”.

In view of the above key issues, the embodiments propose solutions for optimizing the federated EAS discovery.

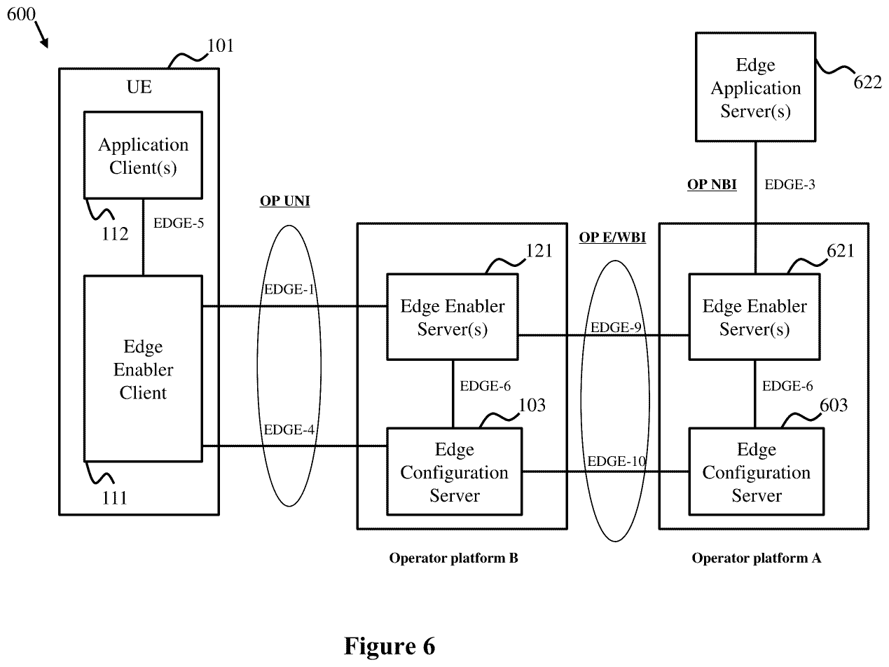

FIG. 6 is a schematic block diagram showing example architecture of a wireless communication system 600, in which the embodiments may be implemented.

In an embodiment, the wireless communication system 600 may be configured in an OTT scenario. The OTT connection may be transparent in the sense that the participating communication devices through which the OTT connection passes are unaware of routing of uplink and downlink communications. For example, a base station may not or need not be informed about the past routing of an incoming downlink communication with data originating from the ECS 103, the EES 121, the ECS 603, the EES 621, or the EAS 622 to be forwarded (e.g., handed over) to a connected UE 101. Similarly, the base station need not be aware of the future routing of an outgoing uplink communication originating from the UE 101 towards the ECS 103, the EES 121, the ECS 603, the EES 621, or the EAS 622.

It should also be understood that, a network function can be implemented either as a network element on a dedicated hardware, as a software instance running on a dedicated hardware, or as a virtualized function instantiated on an appropriate platform, e.g. on a cloud infrastructure.

The embodiments aim to address how to discover an EAS 622, which is deployed in the partner's OP (i.e. OP-A). FIG. 6 may show relationship between edge computing architecture (EDGE APP architecture) and GSMA OPG architecture. The two operator platforms may communicate with each other via EDGE-9 and EDGE-10.

In an embodiment, assumption is that: the EEC 111 in the UE 101 does not have access directly to enabler/configuration server in the OP-A, (i.e., the EEC 111 is not authorized to access the ECS 603 and the EES 621 in OP-A); the OP-B may have an edge service federation (such as a SLA) with the OP-A; and the servers in the OP-B may serve the EEC 111 directly (i.e., the EEC 111 is authorized to access the ECS 103 and the EES 121 in OP-B). For the AC 112 in the UE 101, it may access the EAS(s) 622 deployed in the OP-A.

As specified in “Operator Platform Telco Edge Requirements, Version 1.0, 29 Jun. 2021” (for example, section 2.1.2 and section B7.2) released by GSMA, the edge service federation may allow the Application Provider to use a common interface to manage edge applications deployed towards the subscribers of multiple operators subject to an agreement with the operators involved.

For the case where there are several EDNs coverage for the current UE location and the contracted OP (i.e., OP B) for the EEC 111 cannot provide a desired EAS in its EDN, the embodiments may offer an option so that the EEC contracted OP (i.e., OP B) may use its partner's OP (i.e., OP A) to discover the desired EAS 622 in the partner's EDN for the UE 101.

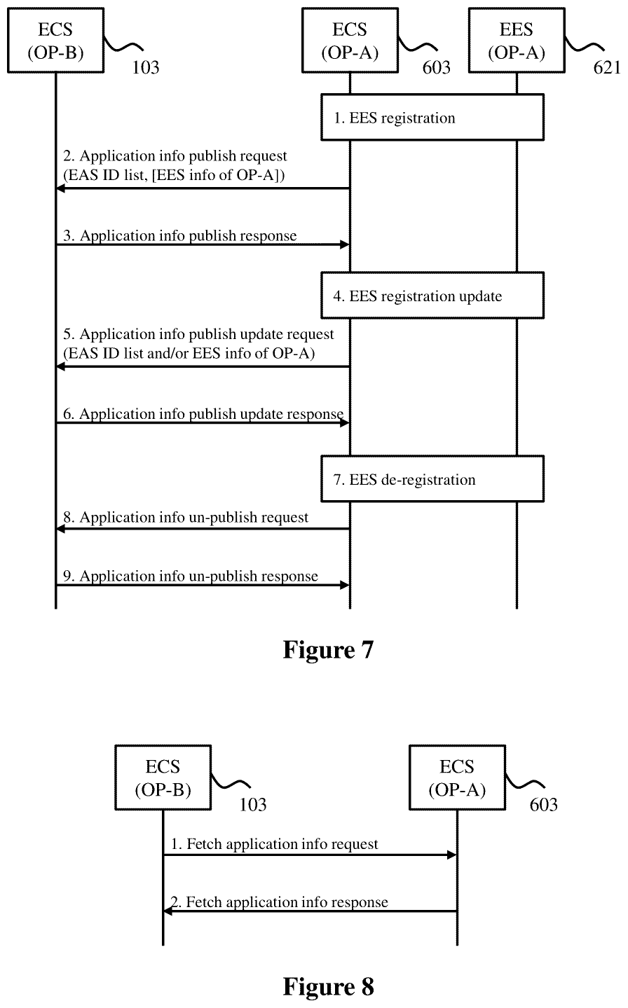

FIG. 7 is a schematic signaling chart showing the messages in an application information publish procedure, according to the embodiments herein.

Since the application instance (such as the EAS 622) is deployed in the partner's data network (OP A), when the leading OP (OP-B) receives a request from the user client (such as the EEC 111), the leading OP (OP-B), which is serving the UE 101, may contact the partner OP (OP-A) to discover the application instance. In EDGEAPP architecture, the EES 103, 603 and ECS 121, 621 may be entities within the OPs (OP A, OP B). The embodiments may provide ways for the leading OP to discover adequate EES(s) of the partner OP for subsequent communication with the partner OP's EES.

The application information publish procedure between the ECSs 103, 603 may include the following messages or steps.

In step 1, the EES 621 of the OP-A may be registered in the ECS 603 of the OP-A over EDGE-6 reference point.

In step 2, based on the information sharing policy in the ECS 603 of the OP-A, the ECS 603 of the OP-A may send an application information publish request with a list of EAS IDs and optionally EES information of the OP-A, over EDGE-10 reference point. The EES information of the OP-A may include an EES endpoint and may include an EES provider ID, an EES service area and/or an EES Service continuity support.

In step 3, the ECS 103 of the OP-B may store the received information and responds with an application information publish response.

In step 4, the ECS 603 of the OP-A may receive an EES registration update from the EES 621 of the OP-A.

In step 5, the ECS 603 of the OP-A may update the previously published information (EAS ID list and/or EES info of OP-A) towards the ECS 103 of the OP-B, over EDGE-10 reference point.

In step 6, the ECS 103 of the OP-B may update the previously stored information and respond with an application information publish update response.

In step 7, the ECS 603 of the OP-A may receive an EES de-registration from the EES 621 of the OP-A.

In step 8, the ECS 603 of the OP-A may request to remove all previously published information towards the ECS 103 of the OP-B, over EDGE-10 reference point.

In step 9, the ECS 103 of the OP-B may remove all previously stored information and respond with an application information unpublish response.

Note that, the application information published/shared to OP-B may also be done in a notification message under subscribe-notify communication model. That is, the ECS 103 of the OP-B may send a subscribe request (application information publish subscribe request, application information publish update subscribe request, or application information un-publish subscribe request) in advance, and the ECS 603 of the OP-A may send the information included in steps 2, 5, or 8 in respective notify messages.

FIG. 8 is a schematic signaling chart showing the messages in an application information fetch procedure, according to the embodiments herein.

The application information fetch procedure between the ECSs 103, 603 may include the following messages or steps.

In step 1, the ECS 103 of the OP-B may send a fetch application information request periodically to the ECS 603 of the OP-A over EDGE-10 reference point, to fetch application information from its partner OP (e.g. OP-A).

In step 2, the ECS 603 of the OP-A may respond with the requested information to the ECS 103 of the OP-B. In such a fetch operation, the fetched information may include a list of EAS IDs and EES information of OP-A.

Note that, if the ECS 103 of the OP-B does not receive EES information of the OP-A from the published/notified application information, the ECS 103 of the OP-B may also fetch it from the ECS 603 of the OP-A via the fetch operation.

In the embodiments, only the metadata (rather than the EAS profile(s)) of the EAS(s) of the partner OP are published, and thus may reduce the data amount to be transferred on the Edge-10 reference point and to be stored on the ECS.

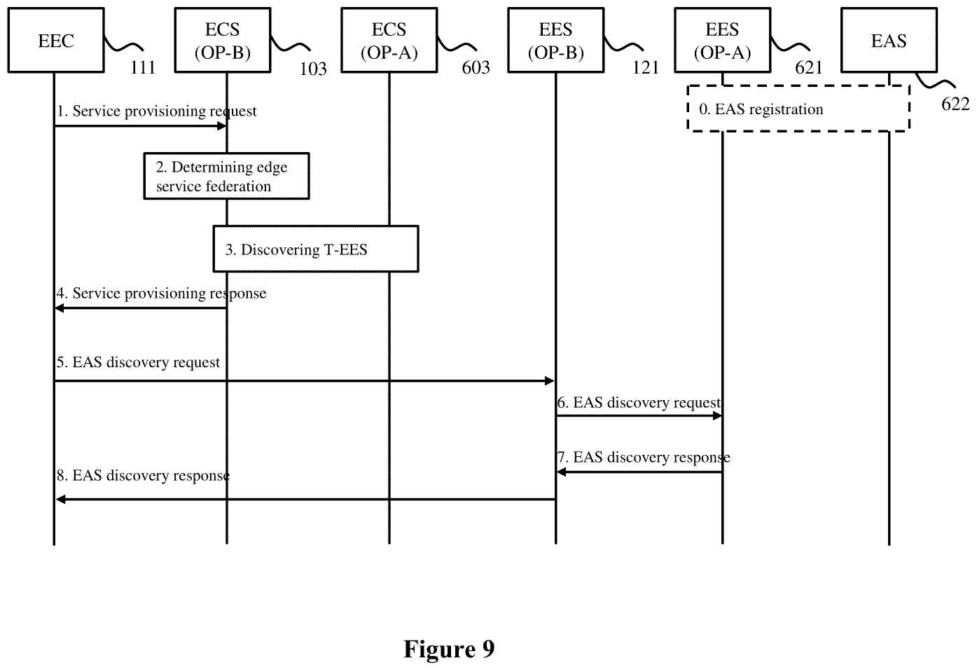

FIG. 9 is a schematic signaling chart showing the messages in a federated EAS discovery procedure, according to the embodiments herein. This procedure may be applicable for EAS discovery without published application information between ECSs 103, 603 as described in FIGS. 7 and 8.

In an embodiment, the signaling chart may include the following messages or steps.

In step 0 (as a precondition), the EAS 622 may be registered in the EES 621 of the OP-A over EDGE-3 reference point. The EAS 622 may be dynamically instantiated during an EAS discovery processing on the EES 621 of the OP-A and then registered in the EES 621 of the OP-A.

Note that, the EES 621 of the OP-A may also be registered into the ECS 603 of the OP-A via EDGE-6 reference point, which is not shown in FIG. 9 for simplicity.

In step 1, the EEC 111 may transmit a service provisioning request message (also referred as the first request message) to the ECS 103 of the OP-B over EDGE-4 reference point.

In step 2, the ECS 103 of the OP-B cannot find any EAS in the EES profile being registered thereon, for providing requested service to the UE 101, so it may determine to use edge service federation.

In step 3, the ECS 103 of the OP-B may discover another ECS (for example the ECS 603 of the OP-A) which may have suitable EES (for example, the EES 621 of OP-A, also referred as the target EES or T-EES) for providing requested service, by using the edge service federation. That is, the ECS 103 may initiate the target EES (T-EES) discovery procedure via EDGE-10 reference point. As a result, the ECS 603 of the OP-A may provide the EES information (such as endpoint) of the target EES 621 to the ECS 103.

Note that, the ECS 103 of the OP-B may have SLA with other multiple OPs and thus may perform step 3 repeatedly with more than one partner OP in order to discover the T-EES.

In step 4, the ECS 103 may determine, based on the edge service federation between the ECS 103 and 603, an EES 121 (also referred as source EES or S-EES) which has SLA with the target EES 621. The source EES 121 is registered on the ECS 103 and is managed by the ECS 103, and the source EES 121 may be same as or different than the EES currently contacting with the UE 101. The endpoint of the source EES 121 of the OP-B may be determined based on SLA with OP-A so that the source EES 121 of the OP-B can be authorized by the target EES 621 of the OP-A. Then, the ECS 103 of the OP-B may transmit a service provisioning response message (also referred as the first response message) to the EEC 111 over EDGE-4 reference point. The service provisioning response may include the EES information (such as EES endpoint) of both the source EES 121 of the OP-B and the target EES 621 of the OP-A.

In an example, the endpoint of the EES 621 of the OP-A may be sent by the ECS 103 of the OP-B in a way that is transparent to the EEC 111, also may be transparent to the UE 101. For example, the EEC 111 may be unaware of receiving such information. In an example, the ECS 103 of the OP-B may generate an access token (such as an encrypted EES access token) and include the endpoint of the EES 621 of the OP-A into the access token. The access token may be used for authorization of EEC 111 by the EES 121 (referring to 3GPP TS33.558).

In step 5, the EEC 111 may transmit an EAS discovery request message (also referred as the second request message) to the EES 121 of the OP-B over EDGE-1 reference point. The EEC 111 may include the information (such as EES endpoint) of the EES 621 of the OP-A in the request message.

In an example, the endpoint of the EES 603 of the OP-A may be transferred between the ECS 103 of the OP-B and the EES 121 of the OP-B transparently to the EEC 111. For example, the EEC 111 may be unaware of transferring such information.

In an example, the endpoint of the EES 621 of the OP-A may be sent via the access token (such as the encrypted EES access token) sent to the EEC 111.

In step 6, the EES 121 of the OP-B may validate the edge service federation (such as the SLA) with the EES 621 of the OP-A. In an example, the EES 121 of the OP-B may validate the EES 621 of the OP-A based on the edge service federation between the ECS 103 and 603. Then, the EES 121 of the OP-B may transmit an EAS discovery request message (also referred as the third request message) over EDGE-9 reference point to the EES 621 of the OP-A. In an example, the EES 121 of the OP-B may decode the access token (such as the encrypted EES access token) sent from the EEC 111 to get the endpoint of the EES 621 of the OP-A.

In step 7, the EES 621 of the OP-A may validate the edge service federation (such as the SLA) with the EES 121 of the OP-B. In an example, the EES 621 of the OP-A may validate the EES 121 of the OP-B based on the edge service federation between the ECS 103 and 603. Then, the EES 621 of the OP-A may return an EAS discovery response message (also referred as the third response message) including the information (such as EAS endpoint(s)) of the discovered candidate EAS(s) 622.

In step 8, the EEC 111 may receive the EAS discovery response message (also referred as the second response message) sent by the EES 121 of the OP-B. The EEC 111 may select an EAS from the discovered candidate EAS(s) 622 for the AC 112.

As seen above, in an embodiment, the ECS may be enhanced with new logic to handle federated edge service and correspondingly, the service provisioning response message may be enhanced with target EES endpoint for which the EEC should ask the contracted EES to contact.

In an embodiment, the EAS discovery request sent by EEC may be enhanced with the target EES endpoint, and the EES may be enhanced with new logic to handle federated edge service upon receipt of such EAS discovery. In an embodiment, the endpoint of EES of partner ECSP may be provided by the leading ECS in a way that is transparent to EEC.

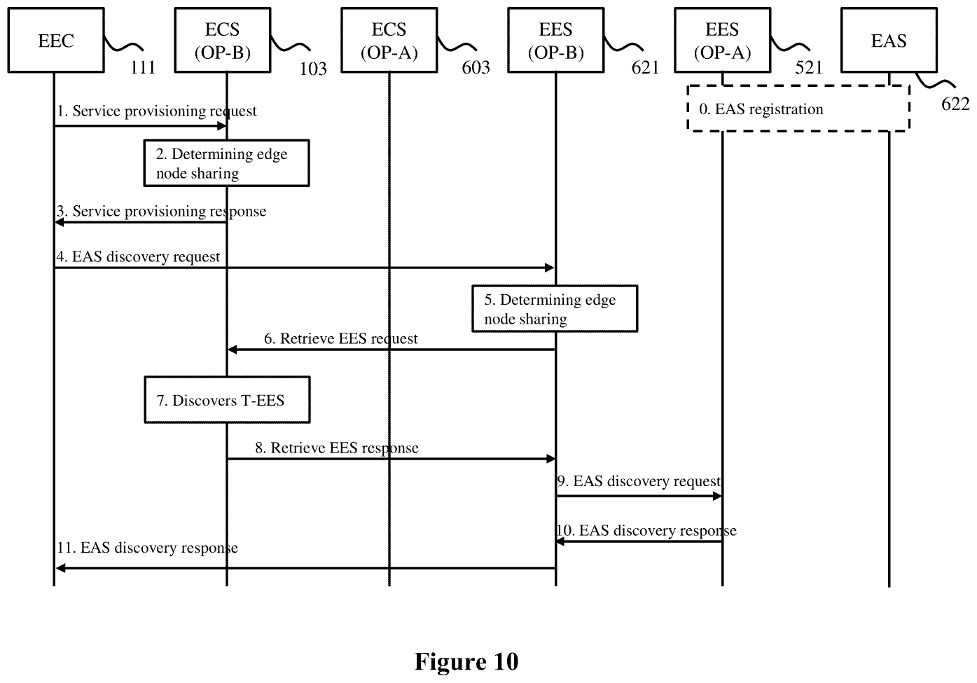

FIG. 10 is a schematic signaling chart showing the messages in another federated EAS discovery procedure, according to the embodiments herein. This procedure may be applicable for EAS discovery with published application information between ECSs 103, 603 as described in FIGS. 7 and 8.

In an embodiment, the signaling chart may include the following messages or steps.

In step 0 (as a precondition), the EAS 622 may be registered in the EES 621 of the OP-A over EDGE-3 reference point. The EAS 622 may be dynamically instantiated during an EAS discovery processing on the EES 621 of the OP-A and then registered in the EES 621 of the OP-A.

Note that, the EES 621 of the OP-A may also be registered into the ECS 603 of the OP-A via EDGE-6 reference point, which is not shown in FIG. 10 for simplicity.

In step 1, the EEC 111 may transmit a service provisioning request message (also referred as the first request message) to the ECS 103 of the OP-B over EDGE-4 reference point.

In step 2, the ECS 103 of the OP-B cannot find any EAS in the EES profile being registered thereon, for providing requested service to the UE 101, so it may determine to use edge service federation. In particular, the ECS 103 of the OP-B may determine to use edge node sharing service from its partner OP-A based on its partner's published application information.

For example, the ECS 103 of the OP-B may determine, based on the edge service federation between the ECS 103 and 603, that the EES 621 of the OP-A may provide the service requested by the EEC 111, and the EES 121 (also referred as source EES or S-EES) of the OP-B have edge service federation with the EES 621 of the OP-A. The source EES 121 is registered on the ECS 103 and is managed by the ECS 103, and the source EES 121 may be same as or different than the EES currently contacting with the UE 101. The endpoint of the source EES 121 of the OP-B may be determined based on SLA with OP-A so that the source EES 121 of the OP-B can be authorized by the target EES 621 of the OP-A.

In step 3, the ECS 103 of the OP-B may transmit a service provisioning response message (also referred as the first response message) to the EEC 111 over EDGE-4 reference point. The service provisioning response may include the EES information (such as EES endpoint) of the source EES 121 of the OP-B.

Note that, the OP-A may have ECSP level SLA with OP-B so that any EES(s) 103 from the OP-B can be authorized by the EES 603 of the OP-A.

In step 4, the EEC 111 may transmit an EAS discovery request message (also referred as the second request message) to the EES 121 of the OP-B over EDGE-1 reference point.

In step 5, the EES 121 of the OP-B cannot find any EAS profile being registered so it determines to use edge node sharing service based on edge service SLA. In an example, the EES 121 of the OP-B may determine an indicator indicating that edge node sharing is requested. For example, the indicator may be an EAS ID.

In step 6, the EES 121 of the OP-B may transmit a Retrieve EES request message (the fourth request message) to the ECS 103 of the OP-B over EDGE-6 reference point. In an example, the EES 121 of the OP-B may include the determined indicator in the Retrieve EES request message.

In step 7, the ECS 103 of the OP-B may discovers the target EES (T-EES) (i.e., EES(s) from partner OP). In an example, based on the received indicator (e.g., the EAS ID), the ECS 103 of the OP-B discovers the T-EES from EES information that was published by partner OP. The optional indicator “edge node sharing (ENS)” may help the ECS 103 of the OP-B to skip the lookup in local EAS information which was registered by the EES(s) 121 of OP-B, because such lookup was already done during service provisioning procedure.

In another example, no indicator is received from the ECS 603 of the OP-A. Then, the ECS 103 of the OP-B may check firstly the local EAS information which was registered by the EES(s) 121 of OP-B, then the ECS 103 of the OP-B may check the shared EAS information which was published by other ECS(s) 603.

In step 8, the ECS 103 of the OP-B may transmit a Retrieve EES response message (also referred as the fourth response message) to the EES 121 of the OP-B over EDGE-6 reference point, to return the discovered EES(s) 621 of OP-A.

In step 9, the EES 121 of the OP-B may transmit an EAS discovery request message (also referred as the third request message) over EDGE-9 reference point to the EES 621 of the OP-A.

In step 10, the EES 621 of the OP-A may validate the edge service federation (such as the SLA) with the EES 121 of the OP-B. In an example, the EES 621 of the OP-A may validate the EES 121 of the OP-B based on the edge service federation between the ECS 103 and 603. Then, the EES 621 of the OP-A may return an EAS discovery response message (also referred as the third response message) including the information (such as EAS endpoint(s)) of the discovered candidate EAS(s) 622.

Note that, the OP-B may have SLA with other multiple OPs, so that the step 9 may be executed with more than one partner OP in order to discover candidate EAS(s).

In step 11, the EEC 111 may receive the EAS discovery response message (also referred as the second response message) sent by the EES 121 of the OP-B. The EEC 111 may select an EAS from the discovered candidate EAS(s) 622 for the AC 112.

The embodiments may address KI #22 for the EAS discovery in edge node sharing case.

If the application information is not shared between the ECS 103, 603 of two OPs having partnership (FIG. 9), during service provisioning, the partner (i.e. OP-A) EES 621 is provided then EEC 111 triggers EAS discovery towards the EES 121 of the contracted OP (i.e. OP-B) in order to obtain EAS information. Any partner information is transparent to the EEC 111 so that the EEC 111 is not aware of the presence of Partner OP (i.e. OP-A).

If the application information is shared between the ECS 103, 603 of two OPs having partnership (FIG. 10), during service provisioning, the EEC 111 may obtain an EES 121 (OP-B) from its OP (i.e. OP-B) and trigger EAS discovery toward the EES 121 (OP-B), then the EES 121 (OP-B) may further obtain EES(s) 621 of a partner OP (OP-A) from its registered ECS 103 (OP-B), continue EAS discovery towards partner OP and return the discovered EAS(s) 622 to the EEC 111.

The embodiments may also address KI #6 for Edge services support across ECSPs, specifically the open issue about how the ECS can discover a T-EES having SLA with S-EES based on the federation agreements between ECSPs before EDGE-9 interaction.

In embodiments of FIG. 10, the EEC 111 in the UE 101 may be unaware of the federated EAS discovery, i.e., the EEC 111 in the UE 101 may do the same actions as the conventional EAS discovery, and thus the impact to the UE 101 may be reduced.

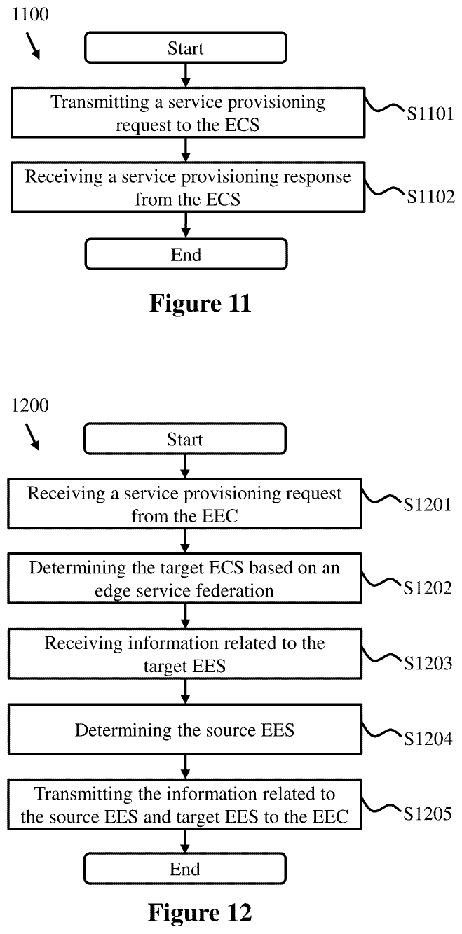

FIG. 11 is a schematic flow chart showing an example method 1100 in the UE 101, according to the embodiments herein. In an embodiment, the flow chart in FIG. 11 may be implemented in the functional component implementing an enabler function (such as the EEC 111) in FIGS. 1-10.

The method 1100 may begin with step S1101, in which the functional component (such as the EEC 111) may transmit a first request message for service provisioning to a first network function (such as the ECS 103) implementing an ECS. In an embodiment, the first request message may be a service provisioning request message over Edge-4 reference point.

Then, the method 1100 may proceed to step S1102, in which the functional component (such as the EEC 111) may receive a first response message from the first network function (such as the ECS 103). In an embodiment, the first response message may be a service provisioning response message over Edge-4 reference point.

The first response message may include a first parameter indicating information related to a second network function (such as the EES 121) implementing an EES managed by the first network function (such as the ECS 103). The first response message may also include a second parameter indicating information related to a third network function (such as the EES 621) implementing an EES managed by a fourth network function (such as the ECS 603) implementing an ECS.

In an embodiment, the first network function (such as the ECS 103) may have an edge service federation (such as SLA) with the fourth network function (such as the ECS 603).

In an embodiment, the second network function (such as the EES 121) may use the edge service federation (such as SLA) for validating the third network function (such as the EES 621).

In an embodiment, the second parameter may be received in a way that is transparent to the functional component (such as the EEC 111) and/or the UE 101.

In an embodiment, the second parameter (such as the endpoint of the EES 621) may be included in an access token (such as the encrypted EES access token) generated by the first network function (such as the ECS 103), so that the second parameter may be transferred transparently to the UE 101.

The above steps are only examples, and the functional component may perform any related actions described with respect to FIGS. 1-10.

FIG. 12 is a schematic flow chart showing an example method 1200 in the first network function, according to the embodiments herein. In an embodiment, the flow chart in FIG. 12 may be implemented in the ECS 103 in FIGS. 1-10.

The method 1200 may begin with step S1201, in which the first network function (such as the ECS 103) may receive a first request message for service provisioning from a functional component (such as the EEC 111) implementing an enabler function in a UE 101. In an embodiment, the first request message may be a service provisioning request message over Edge-4 reference point.

Then, the method 1200 may proceed to step S1202, in which the first network function (such as the ECS 103) may determine a fourth network function implementing an ECS (such as the ECS 603), based on an edge service federation (such as SLA).

Then, the method 1200 may proceed to step S1203, in which the first network function (such as the ECS 103) may receive a message from the fourth network function (such as the ECS 603) over Edge-10 reference point. The message may include a second parameter indicating information related to a third network function (such as the EES 621) implementing an EES managed by the fourth network function (such as the ECS 603).

Then, the method 1200 may proceed to step S1204, in which the first network function (such as the ECS 103) may determine a second network function (such as the EES 121) implementing an EES, which is managed by the first network function (such as the ECS 103), based on the edge service federation.

Then, the method 1200 may proceed to step S1205, in which the first network function (such as the ECS 103) may transmit a first response message to the functional component (such as the EEC 111) in the UE 101. The first response message may include a first parameter indicating information related to the second network function (such as the EES 121), and the second parameter indicating information related to the third network function (such as the EES 621). In an embodiment, the first response message may be a service provisioning response message over Edge-4 reference point.

In an embodiment, the second parameter may be received in a way that is transparent to the functional component (such as the EEC 111) and/or the UE 101.

In an embodiment, the second parameter (such as the endpoint of the EES 621) may be included in an access token (such as the encrypted EES access token) generated by the first network function (such as the ECS 103), so that the second parameter may be transferred transparently to the UE 101.

The above steps are only examples, and the first network function may perform any related actions described with respect to FIGS. 1-10.

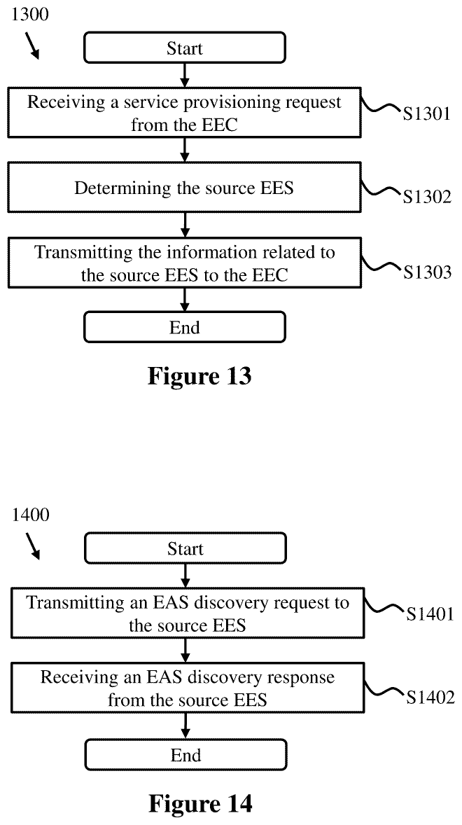

FIG. 13 is a schematic flow chart showing another example method 1300 in the first network function, according to the embodiments herein. In an embodiment, the flow chart in FIG. 13 may be implemented in the ECS 103 in FIGS. 1-10.

The method 1300 may begin with step S1301, in which the first network function (such as the ECS 103) may receive a first request message for service provisionin g, from a functional component (such as the EEC 111) implementing an enabler function in a UE 101. In an embodiment, the first request message may be a service provisioning request message over Edge-4 reference point.

Then, the method 1300 may proceed to step S1302, in which the first network function (such as the ECS 103) may determine, a second network function implementing an EES (such as the EES 121), based on the stored information which was received from a fourth network function implementing an ECS (such as the ECS 603). In an embodiment, the second network function (such as the EES 121) may be managed by the first network function (such as the ECS 103) having an edge service federation with the fourth network function (such as the ECS 603). In an embodiment, the edge service federation may be a SLA.

Then, the method 1300 may proceed to step S1303, in which the first network function (such as the ECS 103) may transmit, to the functional component (such as the EEC 111) in the UE 101, a first response message including a first parameter indicating information related to the determined second network function. In an embodiment, the first response message may be a service provisioning response message over Edge-4 reference point. In an embodiment, the first parameter may indicate the endpoint of the determined second network function.

The above steps are only examples, and the first network function may perform any related actions described with respect to FIGS. 1-10.

FIG. 14 is a schematic flow chart showing an example method 1400 in the UE 101, according to the embodiments herein. In an embodiment, the flow chart in FIG. 14 may be implemented in the functional component implementing an enabler function (such as the EEC 111) in FIGS. 1-10.

The method 1400 may begin with step S1401, in which the functional component (such as the EEC 111) may transmit a second request message for EAS discovery to a second network function (such as the EES 121) implementing an EES. The second request message may include a second parameter indicating information related to a third network function (such as the EES 621) implementing an EES.

In an embodiment, the second parameter (such as the endpoint of the EES 621) may be included in an access token (such as the encrypted EES access token), so that the second parameter may be transferred transparently to the UE 101.

In an embodiment, the second network function (such as the EES 121) and the third network function (such as the EES 621) may be managed by different ECSs having an edge service federation (for example managed by the ECS 103 and the ECS 603 respectively). In an embodiment, the second request message may be an EAS discovery request message over Edge-1 reference point.

Then, the method 1400 may proceed to step S1402, in which the functional component (such as the EEC 111) may receive a second response message from the second network function (such as the EES 121). The second response message may include information (such as the EAS endpoint(s)) related to one or more EASs (such as the EAS(s) 622). In an embodiment, the second response message may be an EAS discovery response message over Edge-1 reference point.

Note that, the schematic flow charts shown in FIG. 11 and FIG. 14 may be performed in sequence (or the schematic flow chart shown in FIG. 14 may be included in the schematic flow chart shown in FIG. 11). That is, after obtaining the EES information of the second network function (such as the EES 121) and the third network function (such as the EES 621) in FIG. 11, the functional component (such as the EEC 111) may initiate the EAS discovery procedure shown in FIG. 14.

The above steps are only examples, and the functional component may perform any related actions described with respect to FIGS. 1-10.

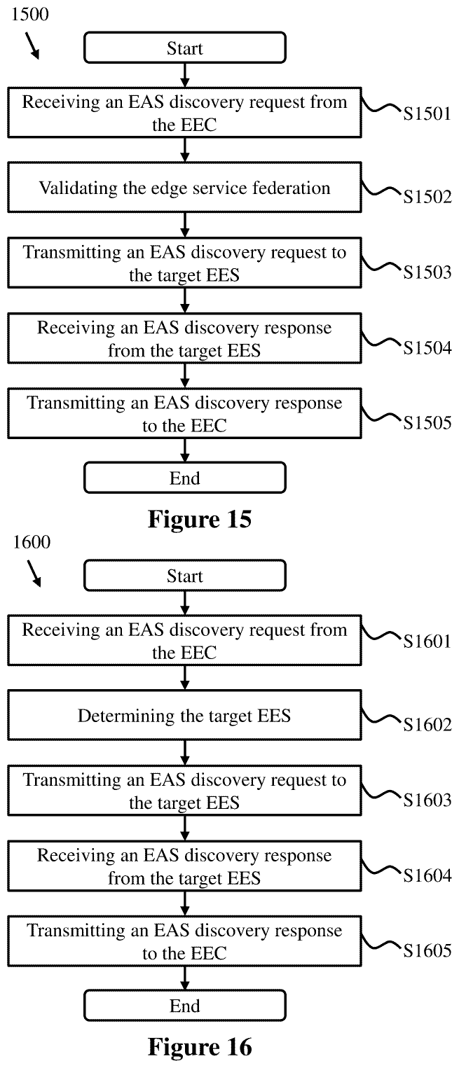

FIG. 15 is a schematic flow chart showing an example method 1500 in the second network function, according to the embodiments herein. In an embodiment, the flow chart in FIG. 15 may be implemented in the EES 121 in FIGS. 1-10.

The method 1500 may begin with step S1501, in which the second network function (such as the EES 121) may receive a second request message for EAS discovery, from a functional component (such the EEC 111) implementing an enabler function in a UE 101. The second request message may include a second parameter indicating information related to a third network function (such as the EES 621) implementing an EES. In an embodiment, the second request message may be an EAS discovery request message over Edge-1 reference point.

In an embodiment, the second parameter (such as the endpoint of the EES 621) may be included in an access token (such as the encrypted EES access token), so that the second parameter may be transferred transparently to the UE 101. In an embodiment, the method 1500 may further comprise the step of decoding the encrypted access token to obtain the second parameter.

In an embodiment, the second network function (such as the EES 121) and the third network function (such as the EES 621) may be managed by different ECSs having an edge service federation (for example managed by the ECS 103 and the ECS 603 respectively).

Then, the method 1500 may proceed to step S1502, in which the second network function (such as the EES 121) may validate the third network function (such as the EES 621) based on the edge service federation between the ECSs (such as ECSs 103 and 603).

Then, the method 1500 may proceed to step S1503, in which the second network function (such as the EES 121) may transmit a third request message for EAS discovery to the third network function (such as the EES 621). In an embodiment, the third request message may be an EAS discovery request message over Edge-9 reference point.

Then, the method 1500 may proceed to step S1504, in which the second network function (such as the EES 121) may receive a third response message including information (such as EAS endpoint(s)) related to the one or more EASs (such as the EAS(s) 622) from the third network function (such as the EES 621). In an embodiment, the third response message may be an EAS discovery response message over Edge-9 reference point.

Then, the method 1500 may proceed to step S1505, in which the second network function (such as the EES 121) may transmit a second response message including information (such as EAS endpoint(s)) related to one or more EASs (such as the EAS(s) 622) to the functional component (such as the EEC 111). In an embodiment, the second response message may be an EAS discovery response message over Edge-1 reference point.

The above steps are only examples, and the second network function may perform any related actions described with respect to FIGS. 1-10.

FIG. 16 is a schematic flow chart showing another example method 1600 in the second network function, according to the embodiments herein. In an embodiment, the flow chart in FIG. 16 may be implemented in the EES 121 in FIGS. 1-10.

The method 1600 may begin with step S1601, in which the second network function (such as the EES 121) may receive a second request message for EAS discovery, from a functional component (such the EEC 111) implementing an enabler function in a UE 101. In an embodiment, the second request message may be an EAS discovery request message over Edge-1 reference point.

Then, the method 1600 may proceed to step S1602, in which the second network function (such as the EES 121) may determine, a third network function (such as the EES 621) implementing an EES, based on an edge service federation.

In an embodiment, the second network function and the third network function may be managed by different ECSs having an edge service federation, for example by the ECSs 103 and 603 respectively. In an embodiment, the edge service federation may be a SLA.

In an embodiment, the determining step S1602 may further comprise the step of transmitting a fourth request message for retrieving a network function, to a first network function (such as the ECS 103) implementing an ECS. In an embodiment, the fourth request message may be a retrieve EES request message over Edge-6 reference point. In an embodiment, the fourth request message may further include an indicator indicating that edge node sharing (ENS) is requested. The indicator may help the ECS 103 to skip the local EES(s), and thus may reduce the time for searching the target EES 621 of the partner operator platform.

In an embodiment, the determining step S1602 may further comprise the step of receiving, from the first network function (such as the ECS 103), afourth response message including information related to the third network function (such as the EES 621). In an embodiment, the fourth response message may be a retrieve EES response message over Edge-6 reference point.

Then, the method 1600 may proceed to step S1603, in which the second network function (such as the EES 121) may transmit, to the determined third network function (such as the EES 621), a third request message for EAS discovery. In an embodiment, the third request message may be an EAS discovery request message over Edge-9 reference point.

Then, the method 1600 may proceed to step S1604, in which the second network function (such as the EES 121) may receive, from the third network function (such as the EES 621), a third response message including information related to one or more EASs. In an embodiment, the third response message may be an EAS discovery response message over Edge-9 reference point.

Then, the method 1600 may proceed to step S1605, in which the second network function (such as the EES 121) may transmit, to the functional component (such as the EEC 111), a second response message including information related to the one or more EASs (such as the EAS 622). In an embodiment, the second response message may be an EAS discovery response message over Edge-1 reference point.

The above steps are only examples, and the second network function may perform any related actions described with respect to FIGS. 1-10.

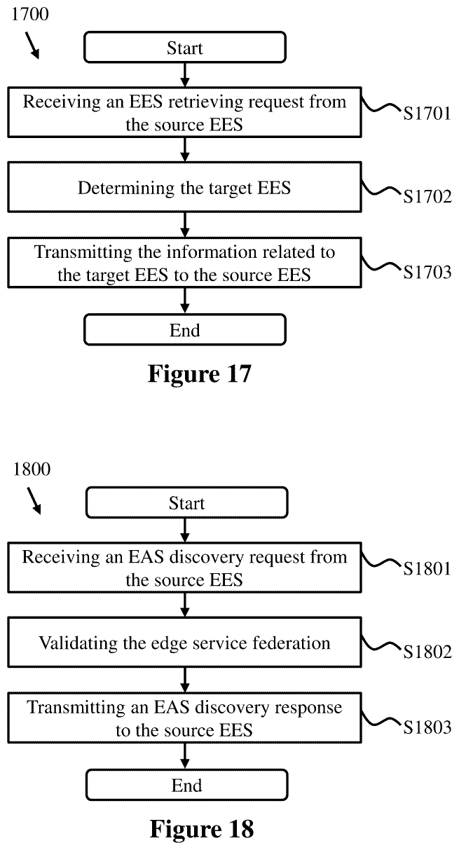

FIG. 17 is a schematic flow chart showing yet another example method 1700 in the first network function, according to the embodiments herein. In an embodiment, the flow chart in FIG. 17 may be implemented in the ECS 103 in FIGS. 1-10.

The method 1700 may begin with step S1701, in which the first network function (such as the ECS 103) may receive a fourth request message for retrieving a network function, from a second network function (such as the EES 121) implementing an EES.

In an embodiment, the fourth request message may be a retrieve EES request message over Edge-6 reference point. In an embodiment, the fourth request message may further include an indicator indicating that edge node sharing is requested. The indicator may help the ECS 103 to skip the local EES(s), and thus may reduce the time for searching the target EES 621 of the partner operator platform.

Then, the method 1700 may proceed to step S1702, in which the first network function (such as the ECS 103) may determine, a third network function implementing an EES (such as the EES 621), based on edge service federation. In an embodiment, determining the third network function may be based on the stored information which was received from a fourth network function (such as the ECS 603) implementing an ECS. In an embodiment, the first network function (such as the ECS 103) may have an edge service federation with the fourth network function (such as the ECS 603). In an embodiment, the edge service federation may be a SLA.

Then, the method 1700 may proceed to step S1703, in which the first network function (such as the ECS 103) may transmit a fourth response message including information related to the third network function (such as the endpoint of the EES 621), to the second network function (such as the EES 121). In an embodiment, the fourth response message may be a retrieve EES response message over Edge-6 reference point.

The above steps are only examples, and the first network function may perform any related actions described with respect to FIGS. 1-10.

FIG. 18 is a schematic flow chart showing an example method 1800 in the third network function, according to the embodiments herein. In an embodiment, the flow chart in FIG. 18 may be implemented in the EES 621 in FIGS. 1-10.

The method 1800 may begin with step S1801, in which the third network function (such as the EES 621) may receive a third request message for EAS discovery from a second network function (such as the EES 121) implementing an EES.

In an embodiment, the second network function (such as the EES 121) and the third network function (such as the EES 621) may be managed by different ECSs having an edge service federation (for example managed by the ECS 103 and the ECS 603 respectively). In an embodiment, the third request message may be an EAS discovery request message over Edge-9 reference point.

Then, the method 1800 may proceed to step S1802, in which the third network function (such as the EES 621) may validate the second network function (such as the EES 121) by using the edge service federation between the ECSs (for example the ECS 103 and the ECS 603).

Then, the method 1800 may proceed to step S1803, in which the third network function (such as the EES 621) may transmit a third response message including information (such as EAS endpoint(s)) related to one or more EASs (such as the EAS(s) 622), to the second network function (such as the EES 121). In an embodiment, the third response message may be an EAS discovery response message over Edge-9 reference point.

The above steps are only examples, and the third network function may perform any related actions described with respect to FIGS. 1-10.

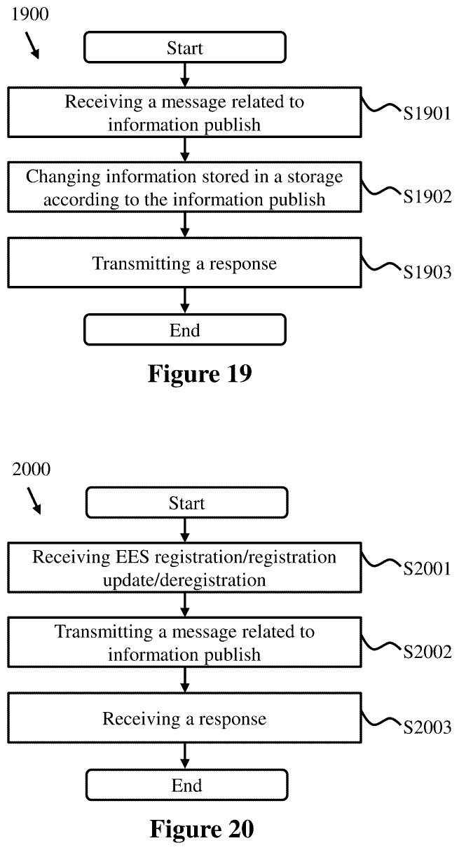

FIG. 19 is a schematic flow chart showing still yet another example method 1900 in the first network function, according to the embodiments herein. In an embodiment, the flow chart in FIG. 19 may be implemented in the ECS 103 in FIGS. 1-10.

In an embodiment, the method 1900 may comprise the step S1901, in which the first network function (such as the ECS 103) may receive, from a fourth network function (such as the ECS 603) implementing an ECS, a fifth message related to information publish. In an embodiment, the first network function 103 may have an edge service federation with the fourth network function 603.

In an embodiment, the fifth message related to information publish may be an application information publish request message over Edge-10 reference point, as shown in step 2 of FIG. 7. In an embodiment, the fifth message may include a list of EAS Ids or includes a list of EAS Ids and information related to an EES.

In an embodiment, the fifth message related to information publish may be an application information publish update request message over Edge-10 reference point, as shown in step 5 of FIG. 7. In an embodiment, the fifth message may include at least one of a list of EAS Ids and information related to an EES.

In an embodiment, the fifth message related to information publish may be an application information unpublish request message over Edge-10 reference point, as shown in step 8 of FIG. 7.

In an embodiment, the fifth message related to information publish may be a fetch application information response message over Edge-10 reference point, as shown in FIG. 8. In an embodiment, the fifth message may include at least one of a list of EAS Ids and information related to an EES.

In an embodiment, the fifth message related to information publish may be an application information publish notify message, an application information publish update notify message, or application information unpublish notify message, in a subscribe-notify procedure.

In an embodiment, the method 1900 may comprise the step S1902, in which the first network function (such as the ECS 103) may change previously stored information according to the fifth message.

In an embodiment, changing the previously stored information may further comprise the step of storing the information included in the fifth message, in response to the application information publish request message.

In an embodiment, changing the previously stored information may further comprise the step of updating the previously stored information by using the information included in the fifth message, in response to the application information publish update request message.

In an embodiment, changing the stored information may further comprise the step of removing the previously stored information, in response to the application information unpublish request message.

In an embodiment, changing the previously stored information may further comprise the step of updating the previously stored information by using the information included in the fifth message, in response to the fetch application information response message.

In an embodiment, the method 1900 may comprise the step S1903, in which the first network function (such as the ECS 103) may transmit a sixth message to the fourth network function (such as the ECS 603).

In an embodiment, the sixth message may be an application information publish response message over Edge-10 reference point, as shown in step 3 of FIG. 7.

In an embodiment, the sixth message may be an application information publish update response message over Edge-10 reference point, as shown in step 6 of FIG. 7.

In an embodiment, the sixth message may be an application information unpublish response message over Edge-10 reference point, as shown in step 9 of FIG. 7.

In an embodiment, the sixth message may be a fetch application information request message over Edge-10 reference point, as shown in FIG. 8. In an embodiment, the sixth message may be an application information publish subscribe message, an application information publish update subscribe message, or application information unpublish subscribe message, in a subscribe-notify procedure.

Note that, the steps in the FIG. 19 do not need to be performed in sequence, that is for the subscribe-notify procedure or application information fetch procedure, the step S1903 may be performed before the steps S1901 and S1902.

The above steps are only examples, and the first network function may perform any related actions described with respect to FIGS. 1-10.

FIG. 20 is a schematic flow chart showing an example method 2000 in the fourth network function, according to the embodiments herein. In an embodiment, the flow chart in FIG. 20 may be implemented in the ECS 603 in FIGS. 1-10.

In an embodiment, the method 2000 may comprise the step S2001, in which the fourth network function (such as the ECS 603) may receive a seventh request message related to EES registration from a third network function (such as the EES 621) implementing an EES.

In an embodiment, the seventh request message related to EES registration may be an EES registration message, as shown in step 1 of FIG. 7.

In an embodiment, the seventh request message related to EES registration may be an EES registration update message, as shown in step 4 of FIG. 7.

In an embodiment, the seventh request message related to EES registration may be an EES de-registration message, as shown in step 7 of FIG. 7.

In an embodiment, the method 2000 may comprise the step S2002, in which the fourth network function (such as the ECS 603) may transmit a fifth message related to information publish, to a first network function (such as the ECS 103) implementing an ECS. In an embodiment, the first network function 103 may have an edge service federation with the fourth network function 603.

In an embodiment, the fifth message related to information publish may be an application information publish request message over Edge-10 reference point, as shown in step 2 of FIG. 7. In an embodiment, the fifth message may include a list of EAS Ids or includes a list of EAS Ids and information related to an EES.

In an embodiment, the fifth message related to information publish may be an application information publish update request message over Edge-10 reference point, as shown in step 5 of FIG. 7. In an embodiment, the fifth message may include at least one of a list of EAS Ids and information related to an EES.

In an embodiment, the fifth message related to information publish may be an application information unpublish request message over Edge-10 reference point, as shown in step 8 of FIG. 7.

In an embodiment, the fifth message related to information publish may be a fetch application information response message over Edge-10 reference point, as shown in FIG. 8. In an embodiment, the fifth message may include at least one of a list of EAS Ids and information related to an EES.

In an embodiment, the fifth message related to information publish may be an application information publish notify message, an application information publish update notify message, or application information unpublish notify message, in a subscribe-notify procedure.

In an embodiment, the method 2000 may comprise the step S2003, in which the fourth network function (such as the ECS 603) may receive a sixth message from the first network function (such as the ECS 103).

In an embodiment, the sixth message may be an application information publish response message over Edge-10 reference point, as shown in step 3 of FIG. 7.

In an embodiment, the sixth message may be an application information publish update response message over Edge-10 reference point, as shown in step 6 of FIG. 7.

In an embodiment, the sixth message may be an application information unpublish response message over Edge-10 reference point, as shown in step 9 of FIG. 7.

In an embodiment, the sixth message may be a fetch application information request message over Edge-10 reference point, as shown in FIG. 8. In an embodiment, the sixth message may be an application information publish subscribe message, an application information publish update subscribe message, or application information unpublish subscribe message, in a subscribe-notify procedure.

Note that, the steps in the FIG. 20 do not need to be performed in sequence, that is for the subscribe-notify procedure or application information fetch procedure, the step S2003 may be performed before the step S2002.

The above steps are only examples, and the fourth network function may perform any related actions described with respect to FIGS. 1-10.

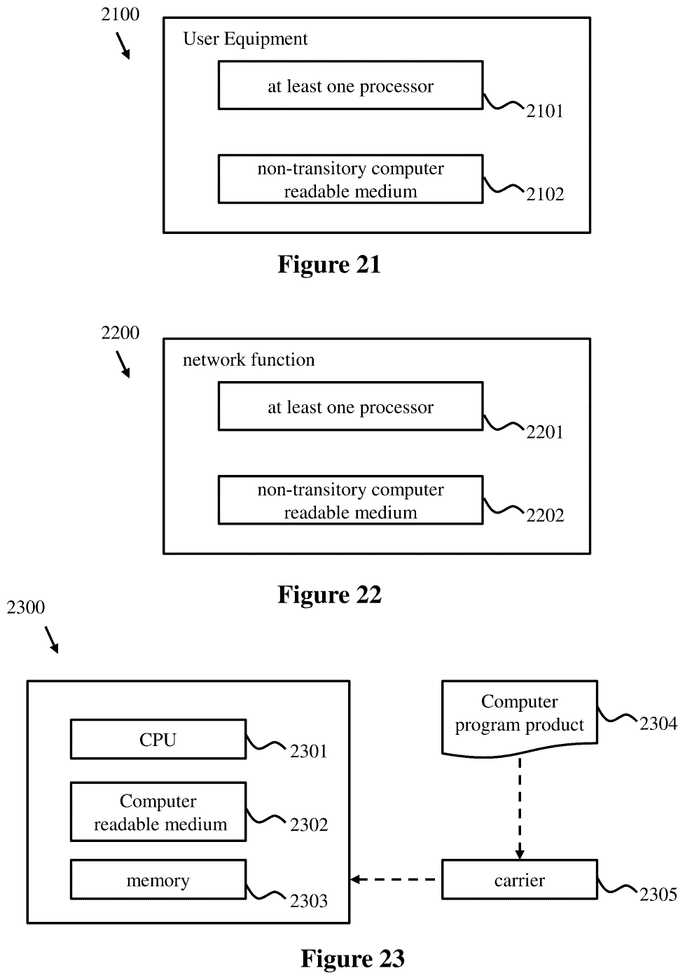

FIG. 21 is a schematic block diagram showing an example UE 2100, according to the embodiments herein.

In an embodiment, the UE 2100 may include at least one processor 2101; and a non-transitory computer readable medium 2102 coupled to the at least one processor 2101. The non-transitory computer readable medium 2102 may store instructions executable by the at least one processor 2101, whereby the at least one processor 2101 is configured to perform the steps in the example methods 1100, 1400 as shown in the schematic flow charts of FIGS. 11 and 14; the details thereof are omitted here.

Note that, the UE 2100 may be implemented as hardware, software, firmware and any combination thereof. For example, the UE 2100 may include a plurality of units, circuities, modules or the like, each of which may be used to perform one or more steps of the example methods 1100, 1400 or one or more steps shown in FIGS. 1-10 related to the UE 101 and its functional component (such as the EEC 111 and/or the AC 112).

FIG. 22 is a schematic block diagram showing an example network function (such as the ECS 103, the EES 121, the EES 621, the ECS 603), according to the embodiments herein.

In an embodiment, the network function 2200 may include at least one processor 2201; and a non-transitory computer readable medium 2202 coupled to the at least one processor 2201. The non-transitory computer readable medium 2202 may store instructions executable by the at least one processor 2201, whereby the at least one processor 2201 is configured to perform the steps in the example methods 1200, 1300, 1500, 1600, 1700, 1800, 1900, 2000 as shown in the schematic flow charts of FIGS. 12-13, and 15-20; the details thereof are omitted here.

Note that, the network function 2200 may be implemented as hardware, software, firmware and any combination thereof. For example, the network function 2200 may include a plurality of units, circuities, modules or the like, each of which may be used to perform one or more steps of the example methods 1200, 1300, 1500, 1600, 1700, 1800, 1900, 2000 or one or more steps shown in FIGS. 1-10 related to the first network function (such as the ECS 103), the second network function (such as the EES 121), the third network function (such as the EES 621), or the fourth network function (such as the ECS 603).

It should be understood that, the network function may be implemented either as a network element on a dedicated hardware, as a software instance running on a dedicated hardware, or as a virtualized function instantiated on an appropriate platform, e.g. on a cloud infrastructure.

FIG. 23 is a schematic block diagram showing an example computer-implemented apparatus 2300, according to the embodiments herein. In an embodiment, the apparatus 2300 may be configured as the above mentioned apparatus, such as the UE 101 or its functional component (such as the EEC 111 and/or AC 112), the first network function (such as the ECS 103), the second network function (such as the EES 121), the third network function (such as the EES 621), or the fourth network function (such as the ECS 603).

In an embodiment, the apparatus 2300 may include but not limited to at least one processor such as Central Processing Unit (CPU) 2301, a computer-readable medium 2302, and a memory 2303. The memory 2303 may comprise a volatile (e.g., Random Access Memory, RAM) and/or non-volatile memory (e.g., a hard disk or flash memory). In an embodiment, the computer-readable medium 2302 may be configured to store a computer program and/or instructions, which, when executed by the processor 2301, causes the processor 2301 to carry out any of the above mentioned methods.

In an embodiment, the computer-readable medium 2302 (such as non-transitory computer readable medium) may be stored in the memory 2303. In another embodiment, the computer program may be stored in a remote location for example computer program product 2304 (also may be embodied as computer-readable medium), and accessible by the processor 2301 via for example carrier 2305.

The computer-readable medium 2302 and/or the computer program product 2304 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Study 3GPP TR 23.700-98 v0.6.0 (2022-04).

Title: Federated EAS discovery

Introduction:

This contribution proposes a new solution for KI #6 and KI #22.

Reason for change:

For the case where there are several EDNs coverage for the current UE location and the contracted OP (Operator Platform) for the EEC cannot provide a desired EAS in its EDN, this solution offers an option so that the EEC contracted OP can use its partner's OP to discover the desired EAS in the partner's EDN for the UE.

Proposed changes:

*** 1st Change *** (the proposed change includes the following the content to be added to the 3GPP Technical Study 23. 700-98)

7.x Solution #XX: Federated EAS discovery

7.x. 1 Architecture enhancements

None.

7.x. 2 Solution description

This solution addressed how to discover an EAS that is deployed in the partner's OP (i.e. OP-A). FIG. 6 shows relationship between EDGEAPP architecture and GSMA OPG architecture. The two operator platforms can communicate with each other via EDGE-9 and EDGE-10.

Assumption is that the EEC in UE does not have access directly to enabler/

configuration server in the OP-A (i.e. the EEC is not authorized to access ECS and EES in OP-A), the OP-B has SLA with OP-A and servers in OP-B can serve the EEC directly (i.e. the EEC is authorized to access ECS and EES in OP-B). For the AC in UE, it can access EAS(s) deployed in OP-A.

For the case where there are several EDNs coverage for the current UE location and the contracted OP for the EEC cannot provide a desired EAS in its EDN, this solution offers an option so that the EEC contracted OP can use its partner's OP to discover the desired EAS in the partner's EDN for the UE.

FIG. 6: Relationship between EDGEAPP architecture and GSMA OPG reference architecture

FIG. 9: Federated EAS discovery

In step 0, the EAS may be registered in EES of OP-A over EDGE-3 reference point. The EAS may be dynamically instantiated during EAS discovery processing on the EES (OP-A) and then registered in the EES (OP-A).

NOTE: The EES (OP-A) also registers into the ECS (OP-A) via EDGE-6 reference point, which is not shown for simplicity.

In step 1, the service provisioning request happens over EDGE-4 reference point, the ECS (OP-B) cannot find any EAS in the EES profile being registered so it determines to use edge service federation.

In step 3, the T-EES discovery procedure happens as described in step 3 of solution #5 via EDGE-10 reference point.

In step 4, the service provisioning response includes the EES (OP-A) endpoint and the ECS (OP-B) determined EES (OP-B) endpoint. The endpoint of EES (OP-B) is determined based on SLA with OP-A so that the EES (OP-B) can be authorized by the EES (OP-A).

In step 5, the EEC sends EAS discovery request to EES (OP-B) over EDGE-1 reference point and include the endpoint of EES (OP-A) in the request.

In step 6, the EES (OP-B) validates the edge service federation and sends EAS discovery request over EDGE-9 reference point to the EES (OP-A).

In step 7, the EES (OP-A) validates the edge service federation and returns EAS discovery response including the discovered candidate EAS(s) to the EES (OP-B).

In step 8, the EEC receives the EAS discovery response sent by the EES (OP-B). The EEC may select an EAS for the AC.

7.x. 3 Solution evaluation

This solution addresses KI #22 for the EAS discovery in edge node sharing case.

This solution also addresses KI #6 for Edge services support across ECSPs,

specifically the open issue about how the ECS can discover a T-EES having SLA with S-EES based on the federation agreements between ECSPs before EDGE-9 interaction.

Furthermore, the following amendments are proposed to amend the current 3GPP Technical Study 3GPP TR 23.700-98 v1.1.1 (2022-07).

Title: Federated EAS discovery

Introduction:

This contribution proposes a new solution for KI #6 and KI #22.

Reason for change:

For the case where there are several EDNs coverage for the current UE location and the contracted OP for the EEC cannot provide a desired EAS in its EDN, this solution offers an option so that the EEC contracted OP can use its partner's OP to discover the desired EAS in the partner's EDN for the UE.

For CC on June 1st:

The OPG. 02 has a service flow depicting inter-OP communication to satisfy an UC (i.e. EEC in the EDGEAPP term) application discovery request. The UC is not aware of the presence of OP Partner, which is also mentioned in clause 3.3.5 of OPG. 02:

The East/Westbound interface enables Operator B's OP to retrieve the application instance access information and provide it to the user. This approach allows performing service discovery and delivery in the same way as when the application was delivered from a Cloudlet in Operator B's own network.

FIG. 4: data source: Operator Platform Telco Edge Requirements, version 2.0

Update after CC on June 1st

Question raised during CC: how to handle subsequent interaction for EDGE-1 (e.g. ACR).

For E/WBI, OPG. 02 also mentions the following requirement in 5.1.2.2:

6.An OP shall be able to act as a proxy for any interaction between operators' networks, hiding any detail on the network architecture of the federated networks.

This explains why UNI is only between the UC and the OP-B.

Update for 50e meeting:

Added a solution for addressing shared app info btw. 2 OPs having partnership, and a new flow for EAS discovery for edge node sharing.

Proposed changes:

1st Change *** (the proposed change includes the following the content to be added to the 3GPP Technical Study 23.700-98 to replace the current content)

2 References

The following documents contain provisions which, through reference in this text, constitute provisions of the present document.
References are either specific (identified by date of publication, edition number, version number, etc.) or non specific.
For a specific reference, subsequent revisions do not apply.
For a non-specific reference, the latest version applies. In the case of a reference to a 3GPP document (including a GSM document), anon-specific reference implicitly refers to the latest version of that document in the same Release as the present document.
[1] 3GPP TR 21.905: “Vocabulary for 3GPP Specifications”.
[2] 3GPP TR 23.558: “Architecture for enabling Edge Applications”.
[3] ETSI ISG MEC ETSI GS MEC 003, “Multi-access Edge Computing (MEC); Framework and Reference Architecture”.
[4] GSMA OPG. 02: “Operator Platform Telco Edge Requirements”, https://www. gsma.com/futurenetworks/resources/gsma-operator-platform-t elco-edge-requirements-2022
[5] 3GPP TS 23.501: “System Architecture for the 5G System; Stage 2”.
[6] 3GPP TR 23.758: “Study on application architecture for enabling Edge Applications”.
[7] 3GPP TR 23.721: “Study on Sponsored Data Connectivity Improvements”.
[8] 3GPP TS 23.502: “Procedures for the 5G System; Stage 2”.
[9] 3GPP TS 23.203: “Policies and Charging control architecture; Stage 2”.
[10] 3GPP TS 23.682: “Architecture enhancements to facilitate communications with packet data networks and applications”.
[11] 3GPP TS 23.503: “Policies and Charging control architecture; Stage 2”.
[12] 3GPP TS 22.261: “Service requirements for the 5G system; Stage 1”.
[13] ETSI GS MEC 010-2: “Multi-access Edge Computing (MEC); MEC Management; Part 2: Application lifecycle, rules and requirements management”.
[14] ETSI GS MEC 011 v3.0.5: “Multi-access Edge Computing (MEC); Edge Platform Application Enablement”.
[15] ETSI GS MEC 001: “Multi-access Edge Computing (MEC); Terminology”.

[16] 3GPP TS 23.222: “Common API Framework for 3GPP Northbound APIs; Stage 2”.
[17] 3GPP TS 29.522: “Network Exposure Function Northbound APIs; Stage 3”.
[18] 3GPP TS 29.122: “T8 reference point for Northbound APIs”.
[19] 3GPP TS 23.548: “5G System Enhancements for Edge Computing; Stage 2”.
[20] 3GPP TS 28.538: “Management and orchestration; Edge Computing Management”.

[x] <doctype>< #> [([up to and including] {yyyy [−mm] |V<a [. b [. c]]>} [onwards])]: “<Title>”.

*** 2nd Change *** (the proposed change includes the following the content to be added to the 3GPP Technical Study 23.700-98 to replace the current content)

4.22 Key issue #22: EAS discovery in Edge Node sharing scenario

Based on GSMA OPG. 02 [4] Operator Platform Telco Edge Requirements, Edge Node sharing scenario has been identified in GSMA OPG. 02 [4], clause 3.3.5.

The deployment case is as follows:

1. OP B deploys application in the OP A (partner OP). OP B wants to scale its services for the region covered by OP A by using OP A's edge infrastructure.

2. User belongs to the OP B.

3. If OP B finds that the most suitable application that can serve the user is available in OP A (partner OP), then OP B requests the edge computing service from OP A (partner OP).

NOTE 1: The user is referred to the subscribers who have edge service authorizations.

Based on the deployment case, it is not clear how to discover and determine the EAS(s) deployed in OP A for OP B users.

FIG. 5 Edge Node sharing scenario

The following study is needed:

1. How can EES discover and determine a EAS which allows (subscribers of OP B) to avail its services?

NOTE 2: The key issue assumes OP A and OP B has the same Edge Computing Architecture (i.e. EDGEAPP).

*** 3rd Change *** (the proposed change includes the following the content to be added to the 3GPP Technical Study 23. 700-98)

7.x Solution #XX: EAS discovery for Edge node sharing

7.x. 1 Architecture enhancements

None.

7.x. 2 Solution description

7.x. 2.1 General

As specified in clause 3.5.4.3.3 of GSMA OPG. 02 [4], Edge node sharing is a scenario wherein an OP, when serving the UNI requests originating from (its own) UCs (i.e. EEC in EDGEAPP term), decides to provide the application from the Edge nodes of a partner OP.

This solution addresses how to discover an EAS that is deployed in the partner's OP (i.e. OP-A) in edge node sharing case. FIG. 6 shows relationship between EDGEAPP architecture and GSMA OPG architecture as depicted in 3GPP TS 23.558 [2] Annex D with EDGE-10 connection between ECS of two operator platforms and the OP E/WBI is proposed to include both EDGE-9 and EDGE-10. The two operator platforms can communicate with each other via EDGE-9 and EDGE-10.

Assumption is that the EEC in UE does not have access directly to enabler/configuration server in the OP-A (e.g. the EEC is not authorized to access ECS and EES in OP-A, or there is no connectivity between the EEC and OP-A), the OP-B has SLA with OP-A and servers in OP-B can serve the EEC directly (e.g. the EEC has connectivity with OP-B and is authorized to access ECS and EES in OP-B). For the AC in UE, it can access EAS(s) deployed in OP-A. This is based on FIG. 5 in KI #22 and FIG. 3 in GSMA OPG. 02 [4] where the application (instance) retrieval relies on E/WBI between OPs.

NOTE: A subscriber of Operator B accesses its home network/operator platform and asks for the required Edge-Enhanced or Edge-Native Application. When Operator B's OP identifies that the most suitable edge node is in Partner A, Operator B's OP requests the Edge Cloud service through the E/WBI to Partner A′s OP. This may be due to the Operator's policy controls, specific Application Provider restrictions, due to constraints originating from the federation agreement between the Operators and others.

Editor's Note: It is needed to verify this assumption with edge node sharing described in GSMA OPG. 02, based on GSMA OPG feedback.

For the case where there are several EDNs coverage for the current UE location and the contracted OP for the EEC cannot provide a desired EAS in its EDN, this solution offers an option so that the EEC contracted OP can use its partner's OP to discover the desired EAS in the partner's EDN for the UE.

FIG. 6: Relationship between EDGEAPP architecture and GSMA OPG reference architecture

7.x. 2.2 Publish/unpublish and fetch application

Since the application instance is deployed in the partner's data network, when the leading OP (OP-B) receives a request from the UC, the leading OP (OP-B) needs to contact the partner OP (OP-A) to discover the application instance. In EDGEAPP architecture, the EES and ECS are entities within the OP. This clause provides ways for the leading OP to discover adequate EES(s) of the partner OP for subsequent communication with the partner OP's EES.

FIG. 7: publish and unpublish application information between ECS

In step 1, the EES of OP-A is registered in ECS of OP-A over EDGE-6 reference point. Based on the information sharing policy in the ECS of OP-A, the ECS of OP-A sends Application info publish request with a list of EAS IDs and optionally EES information of OP-A in step 2. The EES information of OP-A includes EES endpoint and may include EES provider ID, EES service area and/or EES Service continuity support. Then ECS of OP-B stores the received information and responds with Application info publish response in step 3.

The ECS of OP-A may receive EES registration update from the EES of OP-A in step 4, then the ECS of OP-A updates the previously published information (EAS ID list and/or EES info of OP-A) towards the ECS of OP-B in step 5. The ECS of OP-B updates the previously stored information and responds with Application info publish update response in step 6.

The ECS of OP-A may receive EES de-registration from the EES of OP-A in step 7, then the ECS of OP-A requests to remove all previously published information towards the ECS of OP-B in step 8. The ECS of OP-B removes all previously stored information and responds with Application info unpublish response in step 9.

NOTE 1: The application information published/shared to OP-B can also be done in a notification message under subscribe-notify communication model.

FIG. 8: Fetch application information from partner

The ECS (OP-B) may fetch application information from its partner OP (e.g. OP-A) as shown in FIG. 8, periodically. In such a fetch operation, the fetched information includes a list of EAS IDs and EES information of OP-A.

NOTE 2: If the ECS (OP-B) does not receive EES information of OP-A from the published/notified application information, the ECS (OP-B) can also fetch it from the ECS (OP-A) via the fetch operation.

7.x. 2.3 EAS discovery without published application info

This procedure is applicable for EAS discovery without published application information between ECSs as described in clause 7. x. 2.2.

FIG. 9: EAS discovery for edge node sharing, without published application info

In step 0, the EAS may be registered in EES of OP-A over EDGE-3 reference point. The EAS may be dynamically instantiated during EAS discovery processing on the EES (OP-A) and then registered in the EES (OP-A).

NOTE 0: The EES (OP-A) also registers into the ECS (OP-A) via EDGE-6 reference point, which is not shown for simplicity.

In step 1, the service provisioning request happens over EDGE-4 reference point.

In step 2, the ECS (OP-B) cannot find any EAS in the EES profile being registered so it determines to use edge service from its partner OP-A.

In step 3, based on SLA between OPs, the T-EES discovery procedure happens as described in step 3 of solution #5 via EDGE-10 reference point.

NOTE 1: The ECS (OP-B) can have SLA with other multiple OPs and need to repeat step 3 with more than one partner OP in order to discover T-EES.

In step 4, the service provisioning response includes the EES (OP-A) endpoint and the ECS (OP-B) determined EES (OP-B) endpoint. The endpoint of EES (OP-B) is determined based on SLA with OP-A so that the EES (OP-B) can be authorized by the EES (OP-A). The endpoint of EES (OP-A) is sent by EES in a way that is transparent to EEC.

NOTE 2: OP-A can have ECSP level SLA with OP-B so that any EES from OP-B can be authorized by the EES (OP-A).

In step 5, the EEC sends EAS discovery request to EES (OP-B) over EDGE-1 reference point and include the endpoint of EES (OP-A) in the request. The endpoint of EES (OP-A) is transferred between the ECS (OP-B) and the EES (OP-B) transparently to the EEC.

NOTE 3: How the EES (OP-A) endpoint is transferred in a transparent way to EEC between the ECS (OP-B) and the EES (OP-B) is in the scope of SA3.

In step 6, the EES (OP-B) validates the edge service SLA and sends EAS discovery request over EDGE-9 reference point to the EES (OP-A).

In step 7, the EES (OP-A) validates the edge service SLA and returns EAS discovery response including the discovered candidate EAS(s) to the EES (OP-B).

In step 8, the EEC receives the EAS discovery response sent by the EES (OP-B). The EEC may select an EAS for the AC.

7.x. 2.4 EAS discovery with published application info

This procedure is applicable for EAS discovery with published application information between ECSs as described in clause 7. x. 2.2.

FIG. 10: EAS discovery for edge node sharing, with published application info

In step 0, the EAS may be registered in EES of OP-A over EDGE-3 reference point. The EAS may be dynamically instantiated during EAS discovery processing on the EES (OP-A) and then registered in the EES (OP-A).

NOTE 1: The EES (OP-A) also registers into the ECS (OP-A) via EDGE-6 reference point, which is not shown for simplicity.

In step 1, the service provisioning request happens over EDGE-4 reference point.

In step 2, the ECS (OP-B) cannot find any EAS in the EES profile being registered so it determines to use edge node sharing service from its partner OP-A based on its partner's published application information.

In step 3, the service provisioning response includes the ECS (OP-B) determined EES (OP-B) endpoint. The endpoint of EES (OP-B) is determined based on SLA with OP-A so that the EES (OP-B) can be authorized by the EES (OP-A).

NOTE 2: OP-A can have ECSP level SLA with OP-B so that any EES from OP-B can be authorized by the EES (OP-A).

In step 4, the EEC sends EAS discovery request to EES (OP-B) over EDGE-1 reference point.

In step 5, the EES (OP-B) cannot find any EAS profile being registered so it determines to use edge node sharing service based on edge service SLA.

In step 6, the EES (OP-B) sends Retrieve EES request over EDGE-6 reference point to the ECS (OP-B). The request may include an edge node sharing flag indicating edge node sharing is requested so that the ECS (OP-B) can skip checking T-EES(s) registered in the ECS (OP-B).

For the received EAS ID, since the ECS (OP-B) has EES information that was published by partner OP, the ECS (OP-B) discovers T-EES (i.e. EES(s) from partner) in step 7 and returns discovered EES(s) of OP-A in the Retrieve EES response to the ECS (OP-B) in step 8.

In step 9 and 10, the EAS discovery procedure happens over EDGE-9 reference point, which is triggered by the EES (OP-B) and the EES (OP-B) receives the discovered candidate EAS(s).

NOTE 3: The OP-B can have SLA with other multiple OPs so that step 9 can be executed with more than one partner OP in order to discover candidate EAS(s).

Finally, the EEC receives the EAS discovery response sent by the EES (OP-B) in step 11. The EEC may select an EAS for the AC.

7.x. 3 Solution evaluation

This solution addresses KI #22 for the EAS discovery in edge node sharing case.

If the application information is not shared between the ECS of two OPs having partnership, during service provisioning, the partner (i.e. OP-A) EES is provided then EEC triggers EAS discovery towards the EES of the contracted OP (i.e. OP-B) in order to obtain EAS information. Any partner information is transparent to the EEC so that the EEC is not aware of the presence of Partner OP (i.e. OP-A).

If the application information is shared between the ECS of two OPs having partnership, during service provisioning, the EEC obtains an EES (OP-B) from its OP (i.e. OP-B) and triggers EAS discovery toward the EES (OP-B), then the EES (OP-B) further obtains EESs of a partner OP (OP-A) from its registered ECS (OP-B), continues EAS discovery towards partner OP and returns the discovered EASs to the EEC.

This solution also addresses KI #6 for Edge services support across ECSPs, specifically the open issue about how the ECS can discover a T-EES having SLA with S-EES based on the federation agreements between ECSPs before EDGE-9 interaction.

End of Changes

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### Abbreviations

3GPP 3rd Generation Partnership Project
AC Application Client
EAS Edge Application Server
ECS Edge Configuration Server
ECSP Edge Computing Service Provider
EDN Edge Data Network
EEC Edge Enabler Client
EES Edge Enabler Server
ENS Edge Node Sharing
GSMA Global System for Mobile Communications Association
OP Operator Platform
OPG Operator Platform Group
OTT Over The Top
SLA Service Layer Agreement
UE User Equipment.

1. A method performed by a functional component implementing an enabler function in a User Equipment (UE), comprising:
transmitting, to a first network function implementing an Edge Configuration Server (ECS), a first request message for service provisioning; and
receiving, from the first network function, a first response message including a first parameter indicating information related to a second network function implementing an Edge Enabler Server (EES) managed by the first network function, and a second parameter indicating information related to a third network function implementing an EES managed by a fourth network function implementing an ECS.

2. The method according to claim 1, wherein the first network function has an edge service federation with the fourth network function.

3. The method according to claim 2, wherein the second network function uses the edge service federation for validating the third network function.

4. The method according to claim 2, wherein the edge service federation is a Service Layer Agreement (SLA).

5. The method according to claim 1, further comprising:
transmitting, to the second network function, a second request message for Edge Application Server (EAS) discovery, the second request message includes the second parameter; and
receiving, from the second network function, a second response message including information related to one or more EASs.

6. The method according to claim 5, wherein the first request message is a service provisioning request message over Edge-4 reference point;
wherein the first response message is a service provisioning response message over Edge-4 reference point;
wherein the second request message is an EAS discovery request message over Edge-1 reference point; and/or
wherein the second response message is an EAS discovery response message over Edge-1 reference point.

7. The method according to claim 1, wherein the second parameter is received in a way that is transparent to the functional component.

8. The method according to claim 1, wherein the second parameter is included in an access token generated by the first network function.

9. A method performed by a first network function implementing an Edge Configuration Server (ECS), comprising:
receiving, from a functional component implementing an enabler function in a User Equipment (UE), a first request message for service provisioning;
determining a fourth network function implementing an ECS, based on an edge service federation;
receiving, from the fourth network function, a message including a second parameter indicating information related to a third network function implementing an Edge Enabler Server (EES) managed by the fourth network function; and
determining a second network function implementing an EES, which is managed by the first network function, based on the edge service federation.

10. The method according to claim 9, wherein the edge service federation is a Service Layer Agreement (SLA).

11. The method according to claim 9, further comprising:
transmitting, to the functional component in the UE, a first response message including a first parameter indicating information related to the second network function, and the second parameter indicating information related to the third network function.

12. The method according to claim 11, wherein the first request message is a service provisioning request message over Edge-4 reference point;
wherein the first response message is a service provisioning response message over Edge-4 reference point; and/or
wherein the message including the second parameter is received over Edge-10 reference point.

13. The method according to claim 11, wherein the second parameter is transmitted in a way that is transparent to the first functional component, and/or the second parameter is included in an access token generated by the first network function.

14.-54. (canceled)

55. A User Equipment (UE), comprising:
at least one processor; and
a non-transitory computer readable medium coupled to the at least one processor, the non-transitory computer readable medium contains instructions executable by the at least one processor, whereby the at least one processor is configured to:
transmit, to a first network function implementing an Edge Configuration Server (ECS), a first request message for service provisioning; and
receive, from the first network function, a first response message including a first parameter indicating information related to a second network function implementing an Edge Enabler Server (EES) managed by the first network function, and a second parameter indicating information related to a third network function implementing an EES managed by a fourth network function implementing an ECS.

56.-58. (canceled)
